(19) United States
(12) Patent Application Publication
(10) Pub. No.: US 2025/0322452 A1
(43) Pub. Date: Oct. 16, 2025

(54) STAKE POOL OF A SYSTEM DIGITAL ASSET-BACKED DATA INTERACTION SYSTEM

(71) Applicant: Flexa Inc., New York, NY (US)

(72) Inventors: Trevor Filter, New York, NY (US); Zachary Kilgore, Brooklyn, NY (US); Tyler Robert Spalding, New York, NY (US)

(73) Assignee: Flexa Inc., New York, NY (US)

(21) Appl. No.: 19/244,042

(22) Filed: Jun. 20, 2025

Related U.S. Application Data
(62) Division of application No. 18/060,402, filed on Nov. 30, 2022.
Application No. 18/060,402 is a continuation of application No. 17/654,367, filed on Mar. 10, 2022.
Application No. 17/654,367 is a continuation-in-part of application No. 16/376,911, filed on Apr. 5, 2019, now Pat. No. 11,431,683.
(60) Provisional application No. 62/672,652, filed on May 17, 2018.

(51) Int. Cl. G06Q 40/00

(52) U.S. Cl. CPC G06Q 40/00

(57) ABSTRACT

A first memory element that stores operational instructions that, when executed by a data interaction computing entity of a system digital asset-based data interaction system, causes the data interaction computing entity to: obtain first and second computing entity real-time information regarding a data interaction between a first and second computing entity, instruct a data interaction backing computing entity of the system digital asset-based data interaction system to lock an amount of system digital assets to back the data interaction, wherein one or more staking computing entities store system digital assets in a stake pool to back one or more data interactions, and when the data interaction is successful: obtain a data interaction fee from one or more of the first and second computing entities, convert the data interaction fee to system digital assets; and provide the system digital assets to the stake pool.

### CROSS-REFERENCE TO RELATED APPLICATIONS

The present U.S. Utility Patent Application claims priority pursuant to 35 U.S.C. § 121as a divisional of U.S. Utility application Ser. No. 18/060,402, entitled “STAKE POOL OF A SYSTEM DIGITAL ASSET-BACKED DATA INTERACTION SYSTEM”, filed Nov. 30, 2022, which claims priority pursuant to 35 U.S.C. § 120 as a continuation U.S. Utility application Ser. No. 17/654,367, entitled “SYSTEM DIGITAL ASSET-BACKED DATA INTERACTION SYSTEM” filed Mar. 10, 2022, which claims priority pursuant to 35 U.S.C. § 120 as a continuation-in-part of U.S. Utility application Ser. No. 16/376,911, entitled “SECURE AND TRUSTED DATA COMMUNICATION SYSTEM” filed Apr. 5, 2019, issued as U.S. Pat. No. 11,431,683 on Aug. 30, 2022, which claims priority pursuant to 35 U.S.C. § 119 (e) to U.S. Provisional Application No. 62/672,652, entitled “OPEN CRYPTOCURRENCY ACCEPTANCE NETWORK AND MOBILE APPLICATION FOR SPENDING CRYPTOCURRENCY,” filed May 17, 2018, expired, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates generally to data communication systems and more particularly to a data communication system where data interactions are collaterally backed by system digital assets.

### Description of Related Art

Secure data communication involves transfer of data over a channel in a secure manner, which typically involves data encryption. For example, public key infrastructure (PKI) is an encryption method and cybersecurity protocol that secures communications between a server and a client by using two different cryptographic keys (e.g., a public key and a private key); the public key to encrypt and the private key to decrypt. PKI is frequently used for sending large files between organizations and for exchanging secure emails. As long as the private key is only possessed by authorized users, then the authorized users are only ones that can decrypt the data. Thus, no matter who receives the encrypted data, without the private key, it is extremely difficult to recover the data.

Security protocols such as Transmission Control Protocol (TCP), Internet Protocol (IP), Hyper Text Transfer Protocol Secure (HTTPS), Post Office Protocol 3 (POP3), and Internet Message Access Protocol (IMAP) are communication protocols that establish secure communications between computing devices and involve encryption. For instance, TCP is used by two commuting devices to exchange data therebetween. The TCP protocol guarantees delivery of data between the computing devices and also guarantees that packets will be delivered in the same order in which they were sent.

Hardware and software implemented secure transmission protocols are used by many infrastructures (e.g., banks) to detect and prevent unauthorized data access. For example, data loss prevention software uses deep content analysis and central policies to identify, monitor, and protect data within a system. As another example, anti-virus or anti-malware software disarms and removes malicious software from computing devices.

Cloud computing solutions allow for secure online file sharing. For example, one online cloud storage system uses 256-bit Advanced Encryption Standard (AES) for files at rest and Secure Sockets Layer (SSL)/Transport Layer Security (TLS) to protect data in transit between user device apps and the servers. SSL/TLS creates a secure tunnel protected by 128-bit or higher Advanced Encryption Standard (AES) encryption and user device applications and infrastructures are regularly tested for security vulnerabilities. The system also requires a login authentication and public files are only viewable by those who have a link to the files. Extensions of such applications allow for authenticated digital signatures and secure management and storage of important files requiring agreement (e.g., contracts).

Close proximity file sharing applications using Bluetooth allow for secure file sharing by creating a peer-to-peer Wi-Fi network between in-range devices where each device creates a firewall around the connection and encrypted files are exchanged. However, detecting in-range devices via a Wi-Fi connection can present some security issues. For instance, if detecting all in range devices, any devices within range can request to send a file and/or attempt to install malware on the initiating device. Further, if the file sharing application is always enabled, the initiating device may inadvertently share data.

The ease of online data exchange presents copyright infringement and internet piracy concerns. For example, copied or illegally downloaded material can be shared via many different platforms (e.g., peer-to-peer file sharing, email, etc.). To combat piracy, cloud based streaming services negotiate licensing to provide content and enforce access control to avoid copyright infringement. For example, data is kept in “the cloud” and is accessed via an internet connection and a subscription. Such services have reduced piracy by providing free and legal content to consumers. However, stream ripping software can allow any user to turn a file being played on any streaming platform into a file that can be saved and duplicated.

Another data exchange security issue is fraud and identity theft. Fraud and identify theft are particularly concerning in financial applications. One issue is that a typical payment card transaction with a merchant involves several steps (e.g., card authorization, clearing, and settlement) and the participation of various entities. Each step and each entity has its own varying security problems.

The steps involved are also inconvenient, time consuming, and result in additional fees. For example, card authorization (e.g., credit or debit card authorization) begins with the cardholder presenting the card to a merchant for goods or service. The merchant uses a credit card machine, software, or gateway to transmit transaction data to their acquiring bank (or its processor). The acquiring bank routes the transaction data to a card-processing network and the card-processing network sends the transaction data to the cardholder's issuing bank. The issuing bank validates that the card has not been reported stolen or lost, confirms whether funds are available, and sends a response code back through the card-processing network to the acquiring bank as to whether the transaction is approved.

Digital assets are digitally stored content that comes with a right to use. As a few examples, digital assets include images, audio, videos, documents (e.g., contracts, legal documents, etc.), cryptocurrency, cryptocurrency tokens, stocks, and intellectual property rights. Distributed ledger technology (DLT) is a digital system that provides a consensus of replicated, shared, and synchronized digital data spread across several nodes. Unlike traditional databases, DLTs often lack central authority. The nodes of a DLT implement a consensus protocol to validate the authenticity of transactions recorded in the ledger.

Distributed ledger technology reduces the risk of fraudulent activity. For example, a blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the network. Once recorded on the blockchain, transactions cannot be altered.

A cryptocurrency is a digital asset that is securely created and transferred via cryptography. Many cryptocurrencies are distributed networks based on distributed ledger technology (e.g., a blockchain). Decentralized networks like Bitcoin use pseudo-anonymous transactions that are open and public (i.e., anyone can join, create, and view transactions). To eliminate fraudulent transactions and deter malicious network activity, cryptocurrency transactions can be recorded by “miners” using “proof of work” secure hashing algorithms (SHA-256) that require significant computing power. While many cryptocurrencies are blockchain based, other distributed ledger technologies may be used. For example, asynchronous consensus algorithms enable a network of nodes to communicate with each other and reach consensus in a decentralized manner. This method does not need miners to validate transactions and uses directed acyclic graphs for time-sequencing transactions without bundling them into blocks.

The term collateral refers to an asset that a party to an interaction (e.g., a lender) accepts as security for the interaction (e.g., a loan, margin trading, etc.) and acts as a form of security for the entity. The interaction involves a level of risk or inconvenience for at least one party to the interaction and the collateral facilitates the reduction of that risk and/or inconvenience.

### BRIEF DESCRIPTION OF THE SEVERAL VIEWS OF THE DRAWING(S)

FIG. 1 is a schematic block diagram of an embodiment of a system digital asset-backed data interaction system;

FIG. 2 is a flowchart of an example of a method for execution by a data interaction computing entity of a system digital asset-backed data interaction system;

FIG. 3 is a schematic block diagram of an embodiment of a system digital asset-backed data interaction system;

FIG. 4 is a schematic block diagram of another embodiment of a system digital asset-backed data interaction system;

FIG. 5 is a schematic block diagram of an embodiment of a data interaction smart contract blockchain;

FIG. 6 is a schematic block diagram of another embodiment of a system digital asset-backed data interaction system;

FIGS. 7A-7C are schematic block diagrams of examples of staking entities of a system digital asset-backed data interaction system;

FIGS. 8A-8C are flowcharts of an example of a method of facilitating a data interaction of a system digital asset-backed data interaction system; and

FIGS. 9A-9D are flowcharts of an example of a method of facilitating a data interaction of a system digital asset-backed data interaction system.

### DETAILED DESCRIPTION OF THE INVENTION

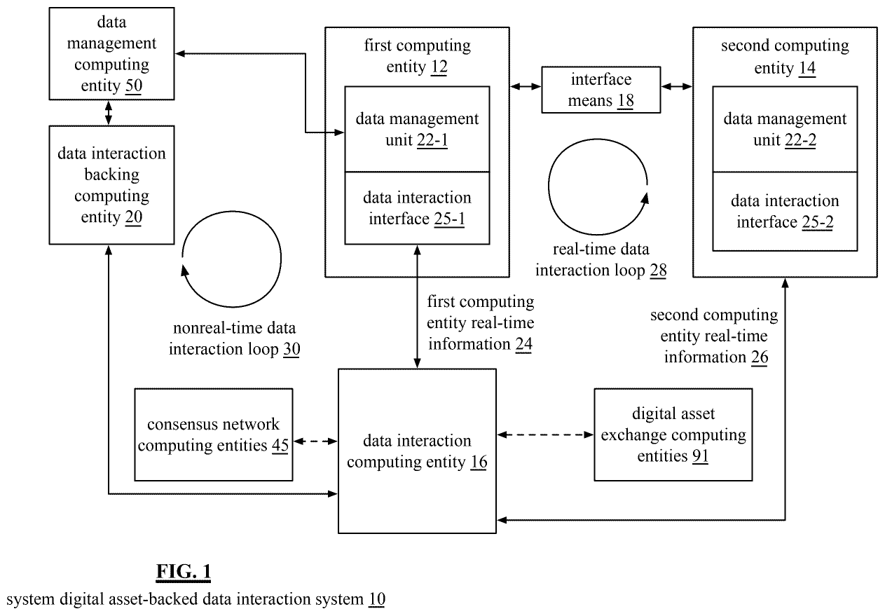

FIG. 1 is a schematic block diagram of an embodiment of a system digital asset-backed data interaction system 10 that includes a first computing entity 12, a second computing entity 14, a data interaction computing entity 16, an interface means 18, a data interaction backing computing entity 20, and a plurality of consensus network computing entities 45. The system digital asset-backed data interaction system 10 facilitates a data interaction (e.g., a payment, a contract, a loan, an exchange of sensitive and/or confidential materials, etc.) between the first computing entity 12 and the second computing entity 14 where the data interaction involves a risk and/or inconvenience to at least one party of the interaction and/or to the data interaction computing entity 16. To mitigate the risk and/or inconvenience, the first computing entity, the second computing entity, and/or the data interaction computing entity 16 requires a collateral backing of system digital assets to facilitate data interactions.

As used herein, a computing entity may be one or more computing devices, one or more distributed computing devices, and/or one or more modules executing on one or more computing devices. Within the system digital asset-backed data interaction system 10, the first computing entity 12, the second computing entity 14, the data interaction computing entity 16, the data interaction backing computing entity 20, the data management computing entity 50, and the plurality of consensus network computing entities 45 may be one or more computing devices, one or more distributed computing devices, and/or one or more modules executing on one or more computing devices.

As used herein, a computing device may be one or more portable computing devices and/or one or more fixed computing devices. The first computing entity 12, the second computing entity 14, the data interaction computing entity 16, the data interaction backing computing entity 20, the data management computing entity 50, and the plurality of consensus network computing entities 45 may be one or more portable computing devices and/or one or more fixed computing devices. A portable computing device may be a social networking device, a gaming device, a cell phone, a smart phone, a digital assistant, a digital music player, a digital video player, a laptop computer, a handheld computer, a tablet, a video game controller, a virtual reality (VR) computing device, a portable merchant point-of-sale (POS) device (e.g., a mobile device with POS capabilities) and/or any other portable device that includes a computing core. A fixed computing device may be a computer (PC), a computer server, a cable set-top box, a satellite receiver, a television set, a printer, a fax machine, home entertainment equipment, a video game console, a fixed merchant point-of-sale (POS) device (e.g., attended cash register, unattended register, etc.), and/or any type of home or office computing equipment.

The data interaction computing entity 16 is operable to obtain data from one or more of the first and second computing entity, to convert data from one format to another (e.g., connect to the digital asset exchange entities to exchange a digital asset to a fiat currency), provide data to one or more of the first and second computing entity, back data interactions via the data interaction backing computing entity 20 such that data interactions can be secured, and verify, via the consensus network computing entities 45 that a data interaction is executed in accordance with data interaction terms and/or completed successfully.

The plurality of consensus network computing entities 45 (also referred to herein as a “consensus network”) are a plurality of computing entities that implements a verification method associated with a particular digital asset and/or data interaction. For example, the consensus network computing entities 45 are nodes of a distributed ledger technology (DLT) that implement a consensus protocol to validate the authenticity of transactions recorded in the ledger. A blockchain is a type of DLT consisting of a continuously growing list of blocks (i.e., groups of transactions) that are securely linked, continually reconciled, and shared among all network participants (i.e., a decentralized network). Transactions are validated and added to blocks via hashing algorithms, and then permanently written to the chain via consensus of the network. Once recorded on the blockchain, transactions cannot be altered.

The data interaction computing entity 16 is operable to back data interactions via the data interaction backing computing entity 20 by locking system digital assets as collateral. The system digital assets stored and managed by the data interaction backing computing entity 20 are associated with the one or more party to the data interaction and/or the type of data involved. Digital assets are digitally stored content that comes with a right to use. As a few examples, digital assets include images, audio, videos, documents (e.g., contracts, legal documents, etc.), cryptocurrency, cryptocurrency tokens, digital fiat currency, stocks, and intellectual property rights. The system digital assets may be any digital asset that the system digital asset-backed data interaction system chooses to consistently use for internal collateral backing. For example, the system digital asset is a token on the Ethereum blockchain specifically created for use in the system digital asset-backed data interaction system. As another example, the system digital asset is an already established and trusted cryptocurrency.

Each of the first and second computing entities 12 and 14 include a data management unit 22-1 and 22-2 respectively. The data management units 22-1 and/or 22-2 may be digital wallet applications or network enabled smart contract applications (e.g., data interaction smart contract wallets) installed on or otherwise usable by the first and second computing entities 12 and 14 that function to store and manage (e.g., transfer, trade, custody, etc.) data. A network enabled smart contract application allows a user to upload data to a network enabled smart contract using a key (e.g., a non-custodial data management unit).

A smart contract is a self-enforcing agreement written in computer code that can be embedded in distributed ledger technology (DLT). For example, a blockchain such as the Ethereum blockchain is operable to manage, execute, and/or run smart contracts. A smart contract contains a set of conditions under which the parties to the self-enforcing smart contract agree to interact. The code and the conditions can be publicly or privately available on the ledger. When an event outlined in the self-enforcing smart contract is triggered, the code is executable (e.g., automatically or based on a data input instructing the code to execute). A self-enforcing smart contract is written to a blockchain or similar database implementation, and executable by consensus network computing entities.

Alternatively, a data management unit may be an application that facilitates receiving data during an interaction such as a data processing application and/or POS software and/or hardware that may or may not include a digital wallet function depending on the types of data the computing entity wishes to interact with.

The data management units 22-1 and/or 22-2 may be data management applications associated with a custodial data management computing entity 50 that may be specially licensed and insured to hold data (e.g., a digital asset holding and management company, a cryptocurrency holding company, a cryptocurrency holding and exchange company, etc.). Alternatively, the data management units 22-1 and/or 22-2 may be non-custodial data management applications associated with a non-custodial data management computing entity 50 (e.g., a digital asset exchange company) where the data management units 22-1 and/or 22-2 store data and the first and second computing entities 12-14 manage private keys to the data management units 22-1 and/or 22-2.

Alternatively, the data management units 22-1 and/or 22-2 may be custodial or non-custodial digital data management applications associated with the data interaction computing entity 16 (e.g., where the data interaction computing entity 16 is a data management computing entity 50).

The data interaction backing computing entity 20 may be a part of or separate from the data interaction computing entity 16. The data interaction backing computing entity 20 stores (or otherwise has access to) and manages system digital assets (e.g., system cryptocurrency, system tokens, etc.) as collateral to back data interactions of the system digital asset-backed data interaction system 10. The data interaction backing computing entity 20 is associated with the first computing entity 12, the second computing entity 14 and/or a type of data (e.g., a cryptocurrency, a loan, contract, etc.). As an example, the data interaction backing computing entity 20 is associated with the data management unit 22-1 of the first computing entity 12.

The data management computing entity 50 is associated with the data interaction backing computing entity 20 via one or more data interaction backing accounts and is operable to deposit system digital assets into the one or more data interaction backing accounts to back data interactions of users of an associated data management unit (e.g., data management unit 22-1). The data management computing entity 50 is incentivized to back data management unit interactions by receiving rewards from the data interaction backing entity 20 such as a percentage of system digital assets back on successful data interactions (e.g., where one or more participants of the data interaction provides an interaction fee for the collateral backing service and the interaction fee is converted to rewards).

The data management computing entity 50 is also referred to as a staking entity and in this example, is associated with a developer of the data management unit 22-1 (e.g., a digital wallet developer). Because the data management computing entity 50 is backing the data management unit interactions and is rewarded by successful interactions, the data management computing entity 50 is incentivized to produce a quality data management unit that prevents user fraud and to remedy faulty software that affects interaction success. In another embodiment, the data management units 22 may be backed by a different and/or additional type(s) of staking entities such as one or more of the first and second computing entities, one or more user computing devices, one or more merchant computing entities, one or more computing entities associated with a corporation and/or business, etc.

When a computing entity functions to primarily receive data (e.g., the computing entity is a merchant computing device), a data management unit (e.g., data management unit 22-2) is not necessarily associated with a data management entity 50 if it is not associated with the party backing the data interaction (e.g., data is received and not sent). For example, when the second computing entity 14 is a merchant computing entity, the data management unit 22-2 may be merchant POS software enabled for use in the system digital asset-backed data interaction system 10.

The data management units 22-1 and 22-2 include data interaction interfaces 25-1 and 25-2 operable to interface with the data interaction computing entity 16. The data interaction interfaces 25-1 and 25-2 are data interaction computing entity application programming interfaces (APIs) integrated into data management units 22-1 and 22-2 that allow the first and second computing entities 12 and 14 to connect to the data interaction computing entity 16 for data interactions.

A data interaction interface may be included in a data management unit when the data management computing entity 50 deposits system digital assets to back interactions made by the data management unit or in a data management unit that primarily receives data (e.g., a merchant, lender, etc.) via the system digital asset-backed data interaction system 10. The first and second computing entities 12 and 14 are operable to establish an account with the data interaction computing entity 16 to use the data interaction interfaces 25-1 and 25-2. The first and second computing entities 12 and 14 are operable to access features of the data interaction computing entity 16 via the data interaction interfaces 25-1 and 25-2 (e.g., via a direct link or by signing in for temporary use).

The second computing entity 14 may be associated with a particular merchant that facilitates payments from the first computing entity 12 to the merchant. For example, the second computing entity may be a fixed POS computing device, a merchant e-commerce website, a merchant mobile application (“app”), etc. The second computing entity 14 may include payment features tailored to the type of second computing entity 14 involved in a payment. For example, when the second computing entity 14 is a fixed POS computing device (e.g., a register), the second computing entity includes features for in-person payment interaction (e.g., a scanning device, a touchscreen, a receipt printer, etc.).

As another example, when the second computing entity 14 is an e-commerce website or merchant mobile application (“app”) the second computing entity may include a variety of existing payment processing features (e.g., existing hardware and/or software) for processing online payments within existing payment networks (e.g., an Secure Socket Layers (SSL) certificate, e-commerce shopping cart software, order and product management features, customer profile management capabilities, a payment gateway, an e-commerce merchant account with a processing bank to accept credit and debit card payments, etc.).

The first computing entity 12 and the second computing entity 14 interact via the interface means 18. The interface means 18 is one or more of: a direct link and a network connection. The direct link includes one or more of: a scanning device (e.g., video, camera, infrared (IR), barcode scanner, etc.), radio frequency (RF), and/or near-field communication (NFC). The network connection includes one or more local area networks (LAN) and/or one or more wide area networks (WAN), which may be a public network and/or a private network. A LAN may be a wireless-LAN (e.g., Wi-Fi access point, Bluetooth, ZigBee, etc.) and/or a wired LAN (e.g., Firewire, Ethernet, etc.). A WAN may be a wired and/or wireless WAN. For example, a LAN is a personal home or business's wireless network, and a WAN is the Internet, cellular telephone infrastructure, and/or satellite communication infrastructure.

As an example, the first computing entity 12 is a smart phone, the second computing entity 14 is a fixed merchant POS device (e.g., a POS register) and the interface means 18 is the fixed merchant POS device's scanning device (e.g., camera, barcode scanner, etc.). As another example, the first computing entity 12 is a smart phone, the second computing entity 14 is a fixed merchant POS device (e.g., a POS register) and the interface means 18 is the smart phone's scanning device (e.g., a front or back camera).

As another example, the first computing entity 12 is a smart phone, the second computing entity 14 is an online POS connection device (e.g., an e-commerce website or e-commerce mobile app) and the interface means 18 is a network connection. For example, a smart phone uses an internet browser application (via cellular or wireless internet connection) to access a merchant's e-commerce website. As another example, a smart phone uses a network connection to connect to an installed merchant e-commerce mobile app.

As another example, the first and second computing entities 12 and 14 are smart phones and the interface means 18 is a network such as Bluetooth, cellular, and/or Wi-Fi. As yet another example, a combination of interface means 18 is possible. For example, the first computing entity 12 is a smart phone and the second computing entity 14 is an online POS connection device (e.g., an e-commerce website). The e-commerce website is accessed via a network connection interface means 18 on a computing device associated with the user of the first computing entity 12 (e.g., a laptop or desktop computer). The computing device displays information for use by the first computing entity's scanning device (e.g., front or back camera).

In an example of operation, the first computing entity 12 and the second computing entity 14 interact via the interface means 18 to initiate a data interaction (also referred to herein as “interaction”). A data interaction involves sending data from the first computing entity to the second computing entity via the data interaction computing entity 16 (e.g., a loan agreement from the first computing entity to the second computing entity, a digital asset-based payment from the first computing entity to the second computing entity, confidential information from the first computing entity to the second computing entity, a contract from the first computing entity to the second computing entity, etc.) where one or more of the first computing entity 12, the second computing entity 14, and the data interaction computing entity 16 require a system digital asset collateral backing for the exchange of data.

To initiate the interaction, the first computing entity 12 may display a unique scannable code to the second computing entity 14 when the interface means 18 is the second computing entity 14 scanning device where the unique scannable code includes information pertaining to the interaction. As another example, the second computing entity 14 displays a unique scannable code for the first computing entity 12 when the interface means 18 is the first computing entity 12 scanning device. As another example, the first computing entity 12 connects with the second computing entity 14 via a network connection interface means 18 to initiate a data interaction.

During the data interaction initiation, the first computing entity 12 sends first computing entity real-time information 24 to the data interaction computing entity 16 via the data interaction interface 25-1 and/or the second computing entity 14 sends second computing entity real-time information 26 to the data interaction computing entity 16 via its data interaction interface 25-2 (e.g., from requesting a scannable code, from scanning a scannable code, from connecting with the other computing entity, etc.).

The first computing entity real-time information 24 includes at least an identifier (e.g., a user ID), a type of data interaction, and the data involved. The first computing entity real-time information 24 may also include data interaction terms such as a time frame for the data interaction, a performance requirement (e.g., a signature, a payment, etc.), an acknowledgement (e.g., a receipt of payment), an action (e.g., a response), etc. The second computing entity real-time information 26 includes at least an identifier (e.g., a user ID, a merchant ID, etc.). The second computing entity real-time information 26 may also include one or more additional data interaction terms such as a time requirement for the data interaction, a performance requirement, etc. The first computing entity real-time information 24 and the second computing entity real-time information 26 may include further an amount of data involved in the data interaction, an amount of system digital assets, an amount of digital assets to purchase and/or borrow system digital assets, etc.

The first computing entity real-time information 24 and the second computing entity real-time information 26 may include further information and/or metadata such as loyalty information, personal information (address, name, etc.), shipping details, bill splitting information, a request for additional information, etc.

For example, the first computing entity real-time information 24 includes a first computing entity ID, a contract, and data interaction terms related to the contract. Data interaction terms include one or more of a time frame, a performance requirement, an acknowledgment, and an action. For example, the data interaction terms for the contract include a time period for signing the contract, a request that the second computing entity 14 provide collateral to ensure that the contract will be signed in accordance with the terms, and a performance required by the contract (e.g., a service or product is provided).

As another example, the first computing entity real-time information 24 includes a first computing entity ID and a type of digital asset it wishes to use to pay the second computing entity 14. In a digital asset-based payment example, the second computing entity real-time information 26 includes at least a second computing entity ID and a desired asset format (e.g., fiat currency) it wishes to receive payment in.

When the data interaction computing entity 16 receives the first and second computing entity real-time information, the data interaction computing entity 16 initiates: 1) a real-time data interaction process (e.g., the real-time data interaction loop 28) and 2) a nonreal-time data interaction process to reconcile the data interaction with the data interaction backing computing entity 20 (e.g., the nonreal-time data interaction loop 30). The reconciliation of the data interaction with the data interaction backing computing entity 20 occurs within a time frame that is longer than the time frame of the real-time data interaction. For example, the reconciliation of the data interaction with the data interaction backing computing entity 20 occurs over the course of minutes whereas the time frame of the real-time data interaction takes a few seconds.

Within the real-time data interaction loop 28, when at least the first computing entity real-time information is obtained, the data interaction computing entity 16 instructs the data interaction backing computing entity 20 to lock an amount of system digital assets associated with the data interaction. The amount of system digital assets is obtained from one or more of the first and second computing entities or from a pool of stored system digital assets associated with the one or more of the first and second computing entities and/or the data involved in the data interaction. The data interaction computing entity 16 obtains the data from the first computing entity 12 to use in the data interaction. For example, the first computing entity 12 sends the data to the data interaction computing entity 16 via its data interaction interface 25-1.

If the data interaction initiation is terminated (e.g., initiation fails and/or is cancelled by the first and/or the second computing entity) within a certain amount of time prior to the data interaction computing entity 16 continuing with the following steps of the real-time data interaction loop 28 the data interaction is terminated. When the data interaction is terminated, the data interaction computing entity 16 instructs the data interaction backing computing entity 20 to release the amount of locked system digital assets.

When the data is managed by a distributed ledger technology (e.g., the data is a cryptocurrency), sending the data to the data interaction computing entity 16 is a transaction added to the digital asset blockchain of the digital asset used by the first computing entity 12 (e.g., this information is published). However, other details related to the interaction (e.g., the identity of the second computing entity 14, transaction fees owed by the second computing entity 14, etc.) are managed privately by the data interaction computing entity 16 off-chain. Therefore, the system digital asset-backed data interaction system 10 keeps confidential second computing entity 14 related information (e.g., revenue, consumer spending behavior, etc.) and confidential first computing entity 12 related information (e.g., consumer identity of purchases, amount spent at a particular merchant, payees/merchants frequented, etc.) private (i.e., not published on a blockchain for anyone to see).

When the data is not managed by a distributed ledger technology (e.g., the data is a contract, etc.) and data interaction terms are included in the first and/or second computing entity real-time information, the data interaction computing entity 16 interacts with a data interaction smart contract managed by a distributed ledger technology and executable by consensus computing entities to establish and verify the data interaction terms. In some cases, public accountability of verified data interaction terms is desired. For example, details of a contract published to a public smart contract would be difficult to dispute or change. However, parties to a contract may not wish to have every detail of the contract published. Privacy enhancing technologies such as zero knowledge proofs, multiparty computation, and private (e.g., off-chain) smart contracts can help protect confidential information while using the public smart contract to resolve any problems.

Zero-knowledge proofs enable parties to prove properties about data they hold without providing sensitive information about the data. For example, a data input to a smart contract can include a zero-knowledge proof of a particular data input instead of the data itself to conceal private information. Multiparty computations are secure computations on private inputs that enable different parties to carry out a joint computation without revealing private inputs to one another. Off-chain smart contracts are protocols in which parties engage with each other off a public distributed ledger technology (e.g., off a blockchain) and use a public or on-chain smart contract and/or distributed ledger technology as a resolution layer. These protocols are designed such that absent a dispute, little to no data is posted to a public distributed ledger technology. Off-chain smart contracts can be program hiding such that the outside world does not learn the contract's code.

Continuing with the real-time data interaction loop 28, when the data interaction is a digital asset-based payment, the data interaction computing entity 16 connects to the one or more digital asset exchange entities to exchange the amount of the digital asset received from the first computing entity 12 to an amount in a desired asset format requested by the second computing entity 14. Digital asset exchange is done quickly (e.g., 30 seconds to a few minutes) to account for exchange rate volatility. The exchange can also be performed immediately on a credit-based account to eliminate any pricing volatility. The data interaction computing entity 16 provides the amount in the desired asset format to the second computing entity 14 to complete the real-time portion of the data interaction. Providing the desired digital assets to the second computing entity 14 may include sending the amount directly to the second computing entity 14 and/or sending the amount to a banking computing entity associated with the second computing entity 14

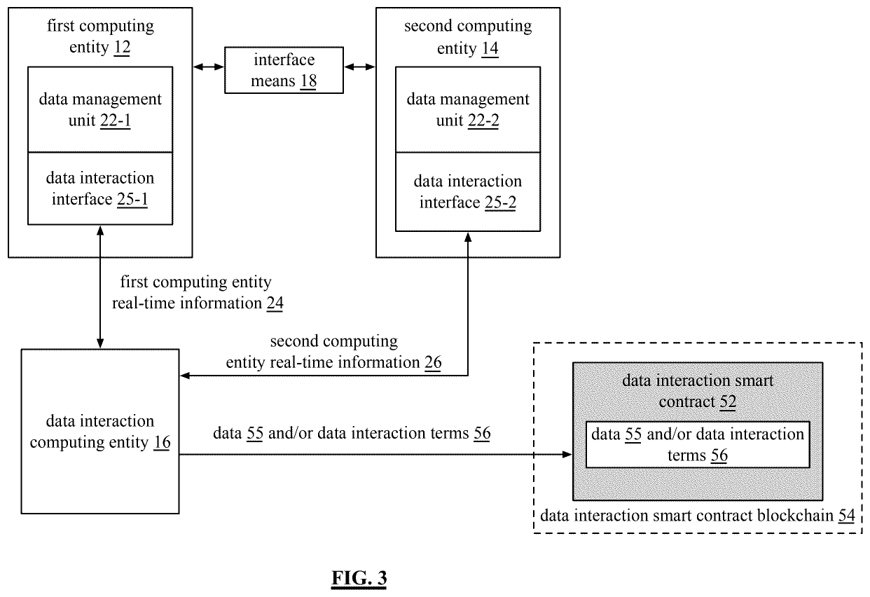

Continuing with the real-time data interaction loop 28, when the at least the first computing entity real-time information includes data interaction terms, the data interaction computing entity 16 interacts with a data interaction smart contract managed by a distributed ledger technology and verified by consensus network computing entities to set and verify the data interaction terms. Interacting with the data interaction smart contract to set and verify the data interaction terms will be discussed in greater detail with reference to FIGS. 3-5. Upon setting the data interaction terms, the data interaction computing entity 16 sends at least a portion of the data to the second computing entity 14 to complete the real-time portion of the data interaction.

For example, when the data interaction is a contract, the data interaction computing entity 16 sends at least a portion of data (e.g., the contract, a signature page, etc.) to the second computing entity 14 to complete the real-time portion of the data interaction (e.g., receive a signature, etc.). In another example, when the data interaction is a loan, the data interaction computing entity 16 sends at least a portion of data (e.g., the loan agreement, a signature page, etc.) to the second computing entity 14 to complete the real-time portion of the data interaction (e.g., receive a signature, etc.).

Continuing with the nonreal-time data interaction loop 30, the data interaction computing entity 16 verifies the data interaction. For example, when the data interaction is a digital asset-based payment, the data interaction computing entity 16 verifies the amount of the digital asset received from the first computing entity 12. For example, the data interaction computing entity 16 connects to the plurality of consensus network computing entities 45 (“a consensus network”) associated with the digital asset that verify the amount of the digital asset received from the first computing entity 12. The consensus network implements a verification process that may take minutes to hours of time.

For example, in the Bitcoin blockchain, miners record new transactions into blocks that verify all previous transactions within the blockchain. At the filing of this application, it takes a miner ten minutes, on average, to write a block on the Bitcoin blockchain. The average block time depends on a total hash power of the Bitcoin network. Once a block is created and a new transaction is verified and included in a block, the transaction will have one confirmation. Each subsequent block (which verifies the previous state of the blockchain) provides one additional network confirmation.

Typically, between 5-10 transaction confirmations (depending on the monetary value of the transaction) are acceptable for cryptocurrency exchanges to avoid losses due to potential fraud. Therefore, if the first computing entity 12 is using Bitcoin, the data interaction computing entity 16 seeks a desired number of confirmations of the amount of the cryptocurrency received by the first computing entity 12 from the consensus network 16 (e.g., via Bitcoin miners). The transaction may not be verified by the data interaction computing entity 16 for an hour or more. As such, the nonreal-time data interaction loop 30 takes longer than the real-time data interaction loop 28.

In another example, when the data interaction is a contract, the data interaction computing entity 16 verifies whether the data interaction terms are met. For example, the data interaction computing entity 16 interacts with a data interaction smart contract managed by a distributed ledger technology verified by consensus network computing entities 45. For example, as the consensus network computing entities 45 verifies each block on the blockchain, the data interaction smart contract executes. Data inputs to and from the data interaction smart contract indicate whether the contract was executed by both parties and whether system digital asset backed performance was achieved. For example, the system digital asset backed performance may include the signing of the contract, a performance under the contract (e.g., a service, delivery of goods, etc.), a condition of the performance (e.g., a quality level, a time frame, etc.), etc. The data interaction computing entity 16 provides and receives data inputs from the data interaction smart contract to verify that the terms are executed.

In another example, when the data interaction is a loan, the data interaction computing entity 16 verifies whether the loan terms are met. For example, the data interaction computing entity 16 interacts with a data interaction smart contract managed by a distributed ledger technology verified by consensus network computing entities 45. Data inputs to and from the data interaction smart contract indicate whether the loan was executed by both parties and whether the system digital asset backed performance was achieved. For example, the system digital asset backed performance may include the signing of the loan documents, a loan performance (e.g., a payment plan of the loan, a received payment, a waiver of the loan, etc.), a condition of the performance (e.g., a time frame to pay the loan, etc.), etc. The data interaction computing entity 16 provides and receives data inputs from the data interaction smart contract to verify that the terms are executed.

In another example, when the data interaction is sending confidential information, the data interaction computing entity 16 verifies whether the confidential information is received. For example, the data interaction computing entity 16 interacts with a data interaction smart contract managed by a distributed ledger technology verified by consensus network computing entities 45. Data inputs to and from the data interaction smart contract indicate whether the confidential information was sent, that the confidential information was received, and whether the system digital asset backed performance was achieved. For example, the system digital asset backed performance may include the receipt of the confidential information and/or a condition of sending the confidential information (e.g., a time frame to send the information, a format of the information, etc.), etc. The data interaction computing entity 16 provides and receives data inputs from the data interaction smart contract to verify that the terms are executed.

Depending on the terms of the data interaction (e.g., a contract, loan, etc.) the nonreal-time data interaction process may take days to months of time (e.g., a loan is to be paid back in three months, a loan has a monthly payment plan lasting one year, etc.). To verify whether the data interaction terms are met, the data interaction computing entity 16 receives one or more data inputs from a smart contract managing the data interaction.

Continuing with the nonreal-time data interaction loop 30, when the data interaction computing entity 16 verifies the data interaction, the data interaction computing entity 16 instructs the digital asset backing entity 20 to release the amount of system digital asset associated with the real-time digital asset interaction. When the data interaction computing entity 16 does not verify the data interaction, the data interaction computing entity 16 and/or the data interaction smart contract perform a consume instruction to consume the amount of system digital assets associated with the data interaction.

The consume instruction involves transferring the system digital assets via an on-chain transaction from one address to another. For example, if fraudulent activity occurs in a digital asset-based payment data interaction (e.g., the first computing entity acts maliciously to spend at two merchants simultaneously, software of the data management unit 22-1 is corrupted, etc.), the data interaction computing entity 16 consumes the amount of system digital asset associated with the data interaction. As a specific example, if the first computing entity 12 attempts to double spend a transaction, the verification (e.g., the desired number of confirmations in a Bitcoin blockchain example) will not be received and the data interaction computing entity 16 will not be able to verify the amount of the digital asset received by the first computing entity 12.

If the verification is not received, the data interaction computing entity 16 withdraws (e.g., consumes) the amount of system digital asset locked by the digital asset backing entity 20 to cover the real-time digital asset interaction that occurred with the second computing entity 14. Consuming the amount of system digital asset means that the amount of system digital asset (or digital assets used to borrow system digital assets) is transferred (e.g., via an on-chain transaction) from an address associated with the digital asset management entity 50 to an address associated with the data interaction computing entity 16.

In another example, when the data interaction is not a digital asset-based payment and the system digital assets are provided by a party to the data interaction (e.g., the first computing entity deposits system digital assets to back a loan agreement) or another staking entity, and verification is not received, the data interaction smart contract transfers the system digital assets to the other party of the data interaction as per the data interaction terms. In another embodiment, the data interaction smart contract transfers the system digital assets to the data interaction computing entity 16 and the data interaction computing entity 16 exchanges the system digital assets to a digital asset desired by the other party. The data interaction computing entity 16 provides the desired digital assets to the other party of the data interaction as per the contract terms.

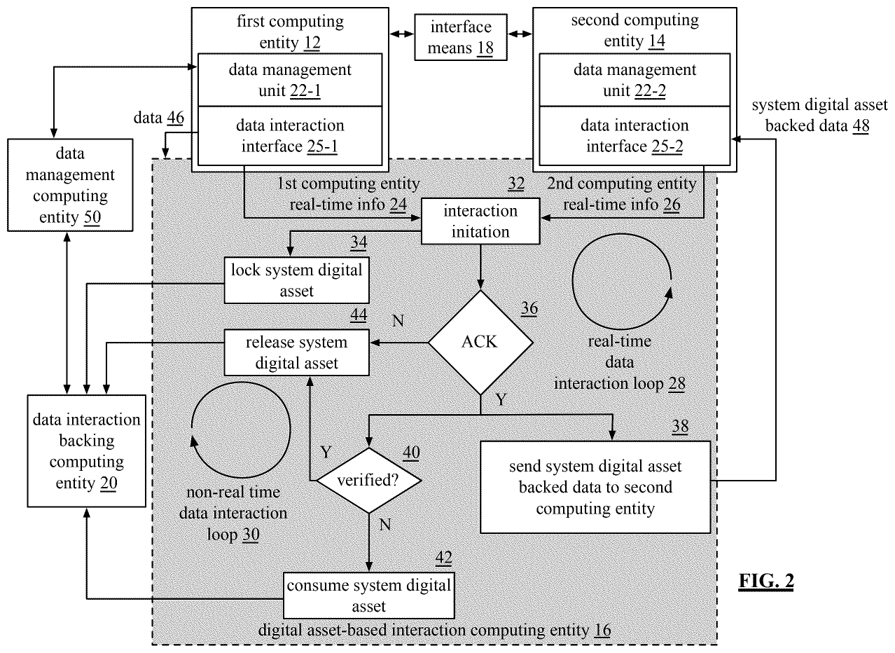

FIG. 2 is a flowchart of an example of a method for execution by a data interaction computing entity 16 of the system digital asset-backed data interaction system 10 of FIG. 1. FIG. 2 includes a first computing entity 12, a second computing entity 14, a data interaction computing entity 16, an interface means 18, a digital asset backing entity 20, and a digital asset management entity 50. The first and second computing entities 12 and 14 include asset management units 22-1 and 22-2 respectively that interface with the data interaction computing entity 16 to facilitate data interactions (also referred to herein as “interactions”) and operate as discussed with reference to FIG. 1.

The second computing entity 14 may be a merchant computing entity that is operable to process payments from a computing entity and includes features tailored to the type of second computing entity 14 it is (e.g., a scanning device, a touchscreen, mobile payment features, online payment features, etc.).

The digital asset management entity 50 is associated with the digital asset backing entity 20 via a data interaction backing account and is operable to deposit system digital assets into its data interaction backing account to back data interactions made by users of its associated data management unit (e.g., data management unit 22-1). In another embodiment, another staking computing entity and/or the first or second computing entity provide system digital assets to the data interaction backing computing entity 20 to back one or more data interactions of the system digital asset-backed data interaction system. The first computing entity 12 and the second computing entity 14 interact via the interface means 18 as discussed with reference to FIG. 1. For example, the interface means 18 is a scanning device of the first computing entity 12 and/or the second computing entity 14.

The method begins with step 32 where a data interaction is initiated. A data interaction is any activity involving sending data between the first computing entity and the second computing entity (e.g., a loan between the first and second computing entity, a payment from the first computing entity to the second computing entity, a contract between the first and second computing entity, confidential information exchange between the first and second computing entity, etc.) that requires a collateral backing (e.g., it presents a risk and/or inconvenience to the first computing entity, the second computing entity, and/or the data interaction computing entity). An interaction is initiated when the first and second computing entities interact via the interface means 18. During the interaction initiation, the data interaction computing entity 16 receives first computing entity real-time information 24 and second computing entity real-time information 26 regarding the data interaction as discussed with reference to FIG. 1.

For example, the first computing entity 12 sends first computing entity real-time information 24 to the data interaction computing entity 16 via the data interaction interface 25-1 of the data management unit 22-1 and the second computing entity 14 sends second computing entity real-time information 26 to the data interaction computing entity 16 via the data interaction interface 25-2 (e.g., from either requesting or scanning a scannable code). As another example, the data interaction interface of the first computing entity 12 or the second computing entity 14 may send the first and second computing entity real-time information 24 and 26 to the data interaction computing entity 16 (e.g., the first computing entity 12 sends the second computing entity and the first computing entity real-time information 24 and 26).

The first computing entity real-time information 24 includes at least an identifier (e.g., a user ID), a type of data interaction, and the data 46 involved. The first computing entity real-time information 24 may also include data interaction terms such as a time frame for the data interaction, a performance requirement (e.g., a signature, a payment, etc.), an acknowledgement (e.g., a receipt of payment), an action (e.g., a response), etc. The second computing entity real-time information 26 includes at least an identifier (e.g., a user ID, a merchant ID, etc.). The second computing entity real-time information 26 may also include one or more additional data interaction terms such as a time requirement for the data interaction, a performance requirement, etc.

The first computing entity real-time information 24 and the second computing entity real-time information 26 may include further an amount of data involved in the data interaction, an amount of system digital assets, an amount of digital assets to purchase and/or borrow system digital assets, etc. The first computing entity real-time information 24 and the second computing entity real-time information 26 may include further information and/or metadata such as loyalty information, personal information (address, name, etc.), shipping details, bill splitting information, a request for additional information, etc.

When the data interaction computing entity 16 receives the real-time information 24-26, the data interaction computing entity 16 initiates 1) a real-time data interaction process (e.g., the real-time data interaction loop 28) and 2) a nonreal-time data interaction process to reconcile the data interaction with the digital asset backing entity 20 (e.g., the nonreal-time data interaction loop 30). The reconciliation of the data interaction with the digital asset backing entity 20 occurs within a time frame that is longer than the time frame of the real-time data interaction.

The method continues with step 34 where, within the real-time data interaction loop 28 (or an initial step of the nonreal-time data interaction loop 30), the data interaction computing entity 16 instructs the data interaction backing computing entity 20 to lock an amount of system digital assets associated with the data interaction. The amount of system digital assets locked may be based on one or more of an amount involved in the data interaction, a type of data interaction, a type of item involved in the data interaction, the first computing entity 12 (e.g., a typical amount the first computing entity 12 spends, an account balance, a trustworthiness level, past data interaction success, a default amount etc.), and the second computing entity 14 (e.g., a trustworthiness level, past data interaction success, the type of merchant the second computing entity 14 is associated with, a type of goods the merchant sells, a default amount, etc.).

When the data interaction is a digital asset-based payment, when the data interaction computing entity 16 locks the system digital asset, a rate quote for the amount of digital asset used by the first computing entity 12 may be locked. An exchange rate is a price at which one digital asset will be exchanged for another. A rate quote is an exchange rate at a given point in time as determined by a digital asset exchange (e.g., cryptocurrency exchange) based on the buying and selling activity of the digital assets within the exchange.

The method continues with step 36 within the real-time data interaction loop 28 where the data interaction computing entity obtains the data 46 from the first computing entity 12 and generates a network acknowledgment (ACK) of the receipt of the data 46. For example, when the data interaction computing entity 16 receives an amount of digital asset from the first computing entity 12 to use in the data interaction, the ACK is generated and the method continues to steps 38 and 40. If the interaction initiation is terminated (e.g., interaction initiation fails and/or is cancelled by the first and/or the second computing entity) within a certain amount of time prior to the data interaction computing entity 16 continuing with the following steps of the real-time data interaction loop 28, the ACK is not generated, and the data interaction terminates. Within the nonreal-time data interaction loop 30, when the ACK is not generated, the method continues with step 44 where the data interaction computing entity 16 instructs the digital asset backing entity 20 to release the amount of locked system digital asset.

Within the real-time data interaction loop 28, when the ACK is generated and the data interaction computing entity 16 receives the data 46 from the first computing entity 12 to use in the data interaction, the method continues with step 38 where the data interaction computing entity 16 sends system digital asset-backed data 48 to the second computing entity 14. When the data interaction is a digital asset-based payment, the data interaction computing entity 16 connects to the one or more digital asset exchange entities to exchange the amount of the digital asset received from the first computing entity 12 to an amount in a desired asset format requested by the second computing entity 14. Digital asset exchange is done quickly (e.g., 30 seconds to a few minutes) to account for exchange rate volatility. The exchange can also be performed immediately on a credit-based account to eliminate any pricing volatility. The data interaction computing entity 16 sends the amount in the desired asset format to the second computing entity 14 to complete the real-time portion of the data interaction.

When the at least the first computing entity real-time information includes data interaction terms, the data interaction computing entity 16 interacts with a data interaction smart contract managed by a distributed ledger technology verified by consensus network computing entities to set and verify the data interaction terms. Interacting with the data interaction smart contract to set and verify the data interaction terms will be discussed in greater detail with reference to FIGS. 3-5. Upon setting the data interaction terms, the data interaction computing entity 16 sends at least a portion of the data as the system digital asset backed data 48 to the second computing entity 14 to complete the real-time portion of the data interaction.

Within the nonreal-time data interaction loop 30, when the ACK is generated at step 36, the method continues with step 40 where the data interaction computing entity 16 verifies the data 46 received from the first computing entity 12. For example, when the data interaction is a digital asset-based payment, the data interaction computing entity 16 verifies the amount of the digital asset received from the first computing entity 12. For example, the data interaction computing entity 16 connects to a plurality of consensus network computing entities (“a consensus network”) associated with the digital asset that verify the amount of the digital asset received from the first computing entity 12. The consensus network implements a verification process that may take minutes to hours of time.

In another example, when the data interaction is a contract, the data interaction computing entity 16 verifies whether the data interaction terms are met. For example, the data interaction computing entity 16 interacts with a data interaction smart contract managed by a distributed ledger technology verified by consensus network computing entities 45. Data inputs to and from the data interaction smart contract indicate whether the contract was executed by both parties and whether system digital asset backed performance was achieved. For example, the system digital asset backed performance may include the signing of the contract, a performance under the contract (e.g., a service, delivery of goods, etc.), a condition of the performance (e.g., a quality level, a time frame, etc.), etc. The data interaction computing entity 16 provides and receives data inputs from the data interaction smart contract to verify that the terms are executed.

Depending on the terms of the data interaction (e.g., a contract, loan, etc.) the nonreal-time data interaction process may take days to months of time (e.g., a loan is to be paid back in three months, a loan has a monthly payment plan lasting one year, etc.). To verify whether the data interaction terms are met, the data interaction computing entity 16 receives one or more data inputs from a data interaction smart contract executed by a plurality of consensus network computing entities.

When the data interaction computing entity 16 verifies the amount of the digital asset received by the first computing entity 12 at step 40, the method continues to step 44 where the data interaction computing entity 16 instructs the digital asset backing entity 20 to release the amount of system digital asset locked for the data interaction. When the data interaction computing entity 16 does not verify the data interaction at step 40, the method continues to step 42 where the data interaction computing entity 16 instructs the digital asset backing entity 20 to perform a consume instruction to consume the amount of system digital assets associated with the data interaction.

The consume instruction involves transferring the system digital assets via an on-chain transaction from one address to another. For example, if fraudulent activity occurs in a digital asset-based payment data interaction (e.g., the first computing entity acts maliciously to spend at two merchants simultaneously, software of the data management unit 22-1 is corrupted, etc.), the data interaction computing entity 16 consumes the amount of system digital asset associated with the real-time digital asset interaction. As a specific example, if the first computing entity 12 attempts to double spend a transaction, the verification (e.g., the desired number of confirmations in a Bitcoin blockchain example) will not be received and the data interaction computing entity 16 will not be able to verify the amount of the digital asset received by the first computing entity 12.

If the verification is not received, the data interaction computing entity 16 withdraws (e.g., consumes) the amount of system digital asset locked by the digital asset backing entity 20 to cover the real-time digital asset interaction that occurred with the second computing entity 14. Consuming the amount of system digital asset means that the amount of system digital asset (or digital assets used to borrow system digital assets) is transferred (e.g., via an on-chain transaction) from an address associated with the digital asset management entity 50 to an address associated with the data interaction computing entity 16.

In another example, when the data interaction is not a digital asset-based payment and the system digital assets are provided by a party to the data interaction (e.g., the first computing entity deposits system digital assets to back a loan agreement) or another staking entity, and verification is not received, the data interaction smart contract transfers the system digital assets to the other party of the data interaction as per the data interaction terms. In another embodiment, the data interaction smart contract transfers the system digital assets to the data interaction computing entity 16 and the data interaction computing entity 16 exchanges the system digital assets to a digital asset desired by the other party. The data interaction computing entity 16 sends the desired digital assets to the other party of the data interaction as per the contract terms.

FIG. 3 is a schematic block diagram of an embodiment of a simplified version of a system digital asset-backed data interaction system 10 that includes a data interaction computing entity 16, a data interaction backing computing entity 20, an interface means 18, first computing entity 12, a second computing entity 14, and a data interaction smart contract blockchain 54. The data interaction computing entity 16, data interaction backing computing entity 20, the interface means 18, the first computing entity 12, and the second computing entity 14 operate similarly to the data interaction computing entity 16, the data interaction backing computing entity 20, the interface means 18, the first computing entity 12, and the second computing entity 14 of FIGS. 1-2.

To initiate a data interaction, the first computing entity 12 and the second computing entity 14 interact via the interface means 18. A data interaction involves sending data from the first computing entity to the second computing entity via the data interaction computing entity 16 (e.g., a loan agreement from the first computing entity to the second computing entity, a digital asset-based payment from the first computing entity to the second computing entity, confidential information from the first computing entity to the second computing entity, a contract from the first computing entity to the second computing entity, etc.) where one or more of the first computing entity 12, the second computing entity 14, and the data interaction computing entity 16 require and/or desire a system digital asset collateral backing for the exchange of data.

During the data interaction initiation, the first computing entity 12 sends first computing entity real-time information 24 to the data interaction computing entity 16 via the data interaction interface 25-1 and/or the second computing entity 14 sends second computing entity real-time information 26 to the data interaction computing entity 16 via its data interaction interface 25-2 (e.g., from requesting a scannable code, from scanning a scannable code, from connecting with the other computing entity, etc.).

The first computing entity real-time information 24 includes at least an identifier (e.g., a user ID), a type of data interaction, and the data involved. The type of data interaction includes one or more of a digital asset-based payment, a loan agreement, a contract, and sending confidential information. When the data interaction is a digital asset-based payment the data involved includes a type of digital asset the first computing entity wishes to use in the digital asset-based payment and a desired asset format that the second computing entity wishes to receive payment in. When the data interaction is not a digital asset-based payment the data involved includes a particular data format for the digital data involved such as documents, pdf files, audio files, and/or any type of digital data.

The first computing entity real-time information 24 may also include data interaction terms such as a time frame for the data interaction, a performance requirement (e.g., a signature, a payment, etc.), an acknowledgement (e.g., a receipt of payment), an action (e.g., a response), etc. The second computing entity real-time information 26 includes at least an identifier (e.g., a user ID, a merchant ID, etc.). The second computing entity real-time information 26 may also include one or more additional data interaction terms such as a time requirement for the data interaction, a performance requirement, etc.

When the data is not already hosted by distributed ledger technology (e.g., the data is a contract, etc., and not a cryptocurrency), the data interaction computing entity 16 interacts with a data interaction smart contract 52 hosted on distributed ledger technology and executable by a plurality of consensus network computing entities. In this example, the distributed ledger technology is a data interaction smart contract blockchain 54. The data interaction smart contract 52 may include one or more privacy enhancing technologies. Privacy enhancing technologies such as zero knowledge proofs, multiparty computation, and off-chain smart contracts can help protect confidential information while using the blockchain to resolve any problems.

The data interaction computing entity 16 embeds the data 55 and/or data interaction terms 56 that it obtained from the first and/or second computing entity real-time information 24 and/or 26 to the data interaction smart contract 52. To embed the data and/or the data interaction terms 56 to the data interaction smart contract 52, the data interaction computing entity 16 sends the data 55 and/or the data interactions terms 56 as one or more data inputs to the data interaction smart contract 52. For example, the data interaction is a contract that includes data interaction terms of a contract signing deadline and a performance associated with the contract (e.g., a service is required by a particular date). The first computing entity 12 sends the contract to the data interaction computing entity 16 and the data interaction computing entity 16 sends the contract to the second computing entity 14. The data interaction computing entity 16 embeds the contract itself and/or one or more of the data interaction terms into the data interaction smart contract as computing code.

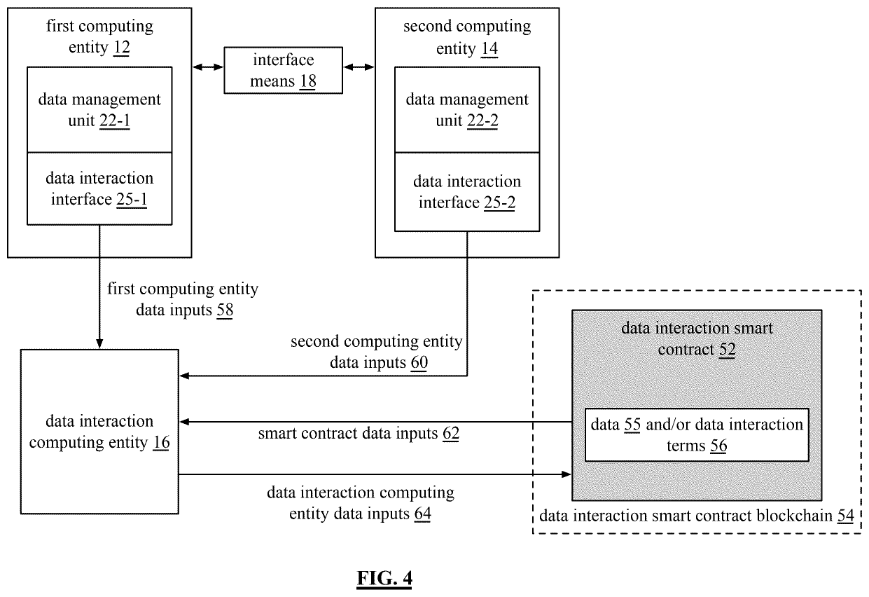

FIG. 4 is a schematic block diagram of an embodiment of a simplified version of the system digital asset-backed data interaction system 10 that includes a data interaction computing entity 16, a data interaction backing computing entity 20, an interface means 18, first computing entity 12, a second computing entity 14, and a data interaction smart contract blockchain 54. The data interaction computing entity 16, data interaction backing computing entity 20, the interface means 18, the first computing entity 12, and the second computing entity 14 operate similarly to the data interaction computing entity 16, the data interaction backing computing entity 20, the interface means 18, the first computing entity 12, and the second computing entity 14 of FIGS. 1-2. FIG. 4 continues the example of FIG. 3 where the data interaction computing entity 16 embedded the data 55 and/or the data interactions terms 56 to the data interaction smart contract 52 as one or more data inputs.

At various times throughout the data interaction, the first computing entity 12 may send one or more first computing entity data inputs 58 to the data interaction computing entity 16 and/or the second computing entity 14 may send one or more second computing entity data inputs 60 to the data interaction computing entity 16. The one or more first and/or second computing entity data inputs 58 or 60 include information pertaining to the data 55 and/or the data interaction terms 56.

Continuing the example of FIG. 3 where the data interaction is a contract that includes data interaction terms of a contract signing deadline and a performance associated with the contract (e.g., a service is required by a particular date), when the contract is signed, the second computing entity 14 provides a second computing entity data input regarding the signature to at least the data interaction computing entity 16. The data interaction computing entity 16 provides the second computing entity data input regarding the signature to the data interaction smart contract 52 as a data interaction computing entity data input 64.

The data interaction computing entity data input 64 triggers code of the data interaction smart contract 52 to execute which verifies whether the signature was completed in accordance with the data interaction terms (e.g., within the time frame). The data interaction smart contract is operable to provide smart contract data inputs 62 to the data interaction computing entity regarding the verification of the data interaction (e.g., whether the data interaction is successful). As block #2 is mined, the smart contract code 72 of block #2 runs. In another embodiment, one or more of the first and second computing entities 12 and 14 are operable to interact directly with the data interaction smart contract 52.

As another example, when the performance associated with the contract is complete, the first and/or second computing entities 12 and/or 14 provides a first and/or second computing entity data input regarding the performance to the data interaction computing entity 16. The data interaction computing entity 16 provides the first and/or second computing entity data input regarding the performance as a data interaction computing entity data input 64 to the data interaction smart contract 52. The data interaction computing entity data input 64 triggers code of the data interaction smart contract 52 to execute and verifies whether the performance was completed in accordance with the data interaction terms (e.g., within a time frame, in accordance with a performance plan, etc.).

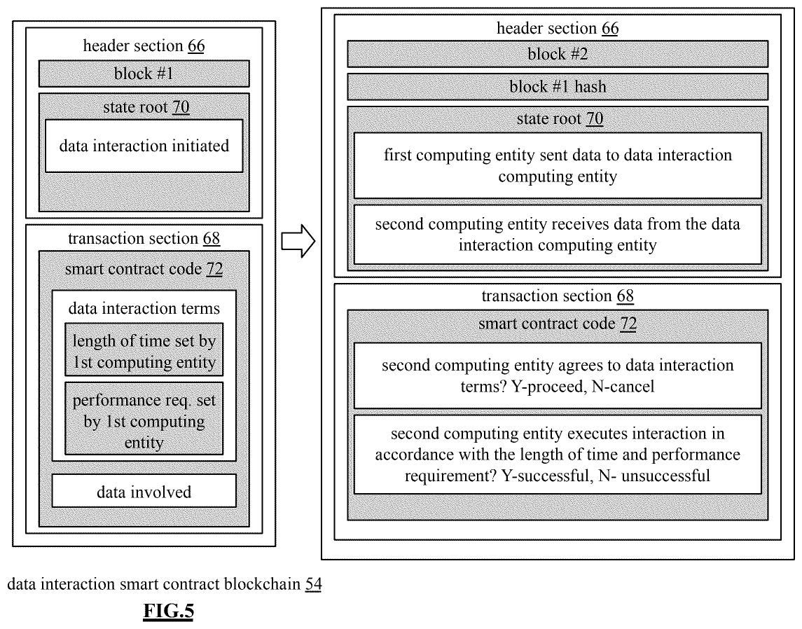

FIG. 5 is a schematic block diagram of an embodiment of a data interaction smart contract blockchain 54. A data interaction smart contract (i.e., a smart contract) is a self-enforcing agreement written in computer code that can be embedded in distributed ledger technology (DLT). For example, a blockchain such as the Ethereum blockchain is operable to manage, execute, and/or run smart contracts. A smart contract contains a set of conditions under which the parties to the smart contract agree to interact. The code and the conditions can be publicly or privately available on the ledger. When an event outlined in the smart contract is triggered, the code is executable (e.g., automatically or based on a data input instructing the code to execute).

The data interaction smart contract is written to a data interaction smart contract blockchain 54 or similar database implementation, and executable by consensus network computing entities. For example, the data interaction smart contract is a smart contract on the Ethereum blockchain. While a blockchain example is shown here, other distributed ledger technologies are possible to manage, run, and/or execute the self-enforcing smart contract code. When an event outlined in the data interaction smart contract is triggered, the code is executable. Therefore, a data interaction smart contract runs exactly as programmed without any possibility of censorship, downtime, fraud, or third party interference.

The Ethereum blockchain is a distributed blockchain network that is able to run programming code of any decentralized application through the use of Turing complete software. The data interaction smart contract blockchain 54 shown is based on a simplified version of an Ethereum blockchain. An Ethereum block includes a header section 66 and a transaction section 68. The structure of the Ethereum blockchain is similar to the structure of other traditional blockchains such as Bitcoin in that it is a shared record of the entire transaction history.

However, an Ethereum block stores not only transactions that have been collected since the last block in the blockchain was mined (like in Bitcoin) but also the recent “state” of each self-enforcing smart contract. A consensus network (i.e., a network of miners) is responsible for shifting the data interaction smart contract from state to state. The header section 66 includes these states in a root hash value (i.e., the state root 70) which summarizes the state changes. The header section 66 further includes other identifying information such as a block number and a hash of a previous block.

The transaction section 68 in Ethereum includes a nonce (a unique transaction identifier), an address of a recipient account, a value, a sending account's signature, code to be run (e.g., smart contract code 72), mining related fields (e.g., start gas and gas price), and possibly some data (e.g., input values for the code). Here, the transaction section 68 is shown as including the smart contract code 72 for simplicity.

FIG. 5 depicts an example of executing a data interaction between a first and second computing entity where a data interaction has been initiated and data and/or data interaction terms are sent to the data interaction computing entity. For simplicity, the executing the data interaction begins with block #1 although numerous blocks would proceed this block. The header section 66 of block #1 includes a state root 70 which includes a current summary of the states of the accounts of the system.

Here, state root 70 includes an entry that the first computing entity and second computing entity have initiated a data interaction. The transaction section 68 of block #1 includes smart contract code 72 which includes code for the data interaction terms and the data involved (e.g., when the data is uploaded/embedded to the data interaction smart contract). The data interaction terms include a length of time to execute the performance of the contract as set by the first computing entity and a performance requirement set by the first computing entity (e.g., the performance meets a standard, the performance is complete, etc.). As block #1 is mined, the smart contract code 72 of block #1 runs.

The header section 66 of block #2 includes a hash of block #1 and a state root 70. The state root 70 includes information pertaining to the current state of the data interaction smart contract accounts. For example, the state root 70 of block #2 states that the first computing entity sent data to the data interaction computing entity and the data interaction computing entity sent data to the second computing entity. For example, when the data interaction terms and data are embedded in the data interaction smart contract, the data interaction computing entity sends a data input to the data interaction smart contract instructing the data interaction smart contract that the data was received and sent to and from the appropriate parties.

The transaction section 68 of block #2 includes smart contract code 72 indicating that when the second computing entity agrees to the data interaction terms (e.g., signs the contract), the data interaction can proceed and if not, the data interaction is canceled. For example, the second computing entity provides a data input to the data interaction computing entity that the contract is signed and the data interaction computing entity provides the input to the data interaction smart contract which triggers the smart contract code to run. The transaction section 68 of block #2 also includes smart contract code 72 indicating that when the second computing entity executes the data interaction in accordance with the length of time and the performance requirement, the data interaction is considered successful. When the second computing entity does not execute the data interaction in accordance with the length of time and the performance requirement, the data interaction is considered unsuccessful.

For example, data inputs provided by the first and/or second computing entities to the data interaction computing entity are provided to the data interaction smart contract indicating whether the data interaction is completed on time and/or in accordance with the performance requirement. These inputs/events trigger the smart contract code to run. The data interaction smart contract is also operable to provide data inputs to the data interaction computing entity (e.g., whether the data interaction is successful). As block #2 is mined, the smart contract code 72 of block #2 runs.

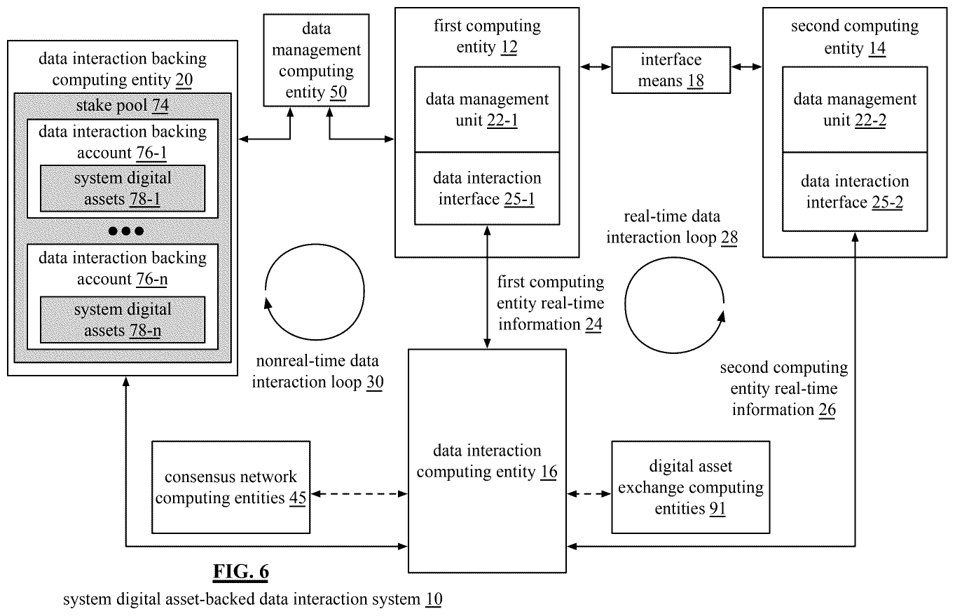

FIG. 6 is a schematic block diagram of an embodiment of a system digital asset-backed data interaction system 10 that includes a first computing entity 12, a second computing entity 14, a data interaction computing entity 16, an interface means 18, a data interaction backing computing entity 20, a data management computing entity 50, a plurality of digital asset exchange computing entities 91, and a plurality of consensus network computing entities 45. The system digital asset-backed data interaction system 10 of FIG. 6 operates similarly to the system digital asset-backed data interaction system 10 of FIG. 1 except that the data interaction backing computing entity 20 is shown in more detail.

The data interaction backing computing entity 20 includes a plurality of data interaction backing accounts 76-1 through 76-n that store system digital assets 78-1 through 78-n respectively. The system digital assets 78-1 through 78-n stored in data interaction backing accounts 76-1 through 76-n form a stake pool 74 of system digital assets. The system digital assets 78-1 through 78-n serve as collateral to back data interactions of the system digital asset-backed data interaction system 10. The system digital assets may be any digital asset that the system digital asset-backed data interaction system chooses to use. For example, the system digital asset is a token on the Ethereum blockchain specifically created for use in the system digital asset-backed data interaction system 10. As another example, the system digital asset is an already established and trusted cryptocurrency.

One or more of the plurality of data interaction backing accounts 76-1 through 76-n is associated with the first computing entity 12, the second computing entity 14, and/or a type of digital asset. As an example, the data interaction backing account 76-1 is associated with the data management unit 22-1 of the first computing entity 12. The data management computing entity 50 is associated with the data interaction backing computing entity 20 via one or more accounts and is operable to deposit system digital assets into the one or more accounts to back data interactions of users of an associated data management unit (e.g., data management unit 22-1). The data interaction management computing entity 50 is incentivized to back data management unit interactions by receiving rewards from the data interaction backing computing entity 20 such as a percentage of system digital assets back on successful interactions. Additionally, the system digital asset provides payment utility such as lower foreign exchange rates.

The data management computing entity 50 is also referred to as a staking entity and in this example, is associated with a developer of the data management unit (e.g., a digital wallet developer). Because the data management computing entity 50 is backing the data management unit interactions and is rewarded by successful transactions, the data management computing entity 50 is incentivized to produce a quality data management unit that prevents user fraud and to remedy faulty software that affects transaction success. In another embodiment, the data management units 22 may be backed by a different and/or additional type(s) of staking entities such as the first computing entity, the second computing entity, one or more user computing devices, one or more merchant computing entities, one or more computing entities associated with a corporation and/or business, etc.

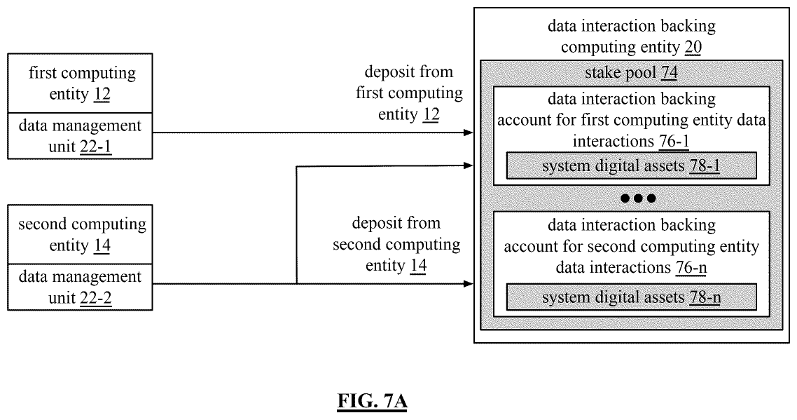

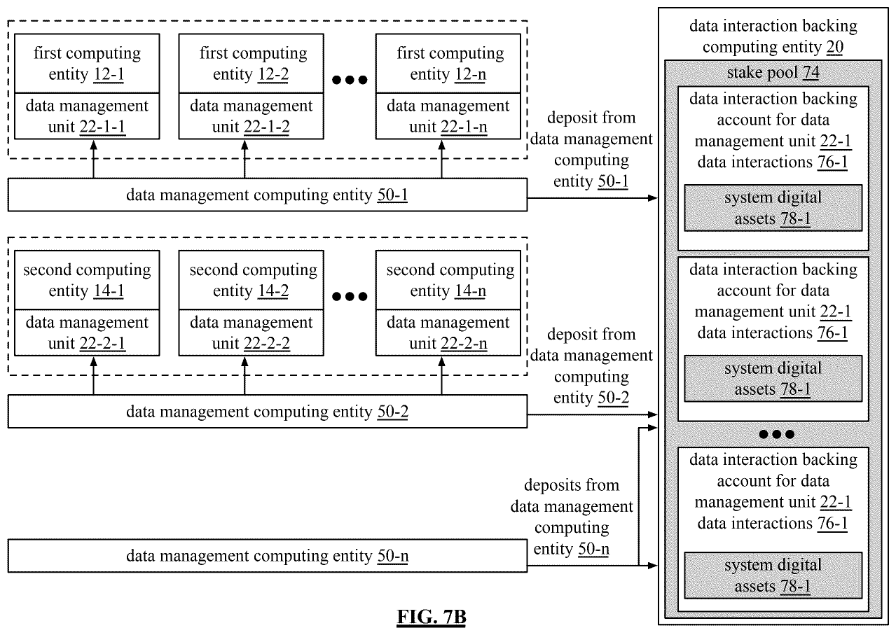

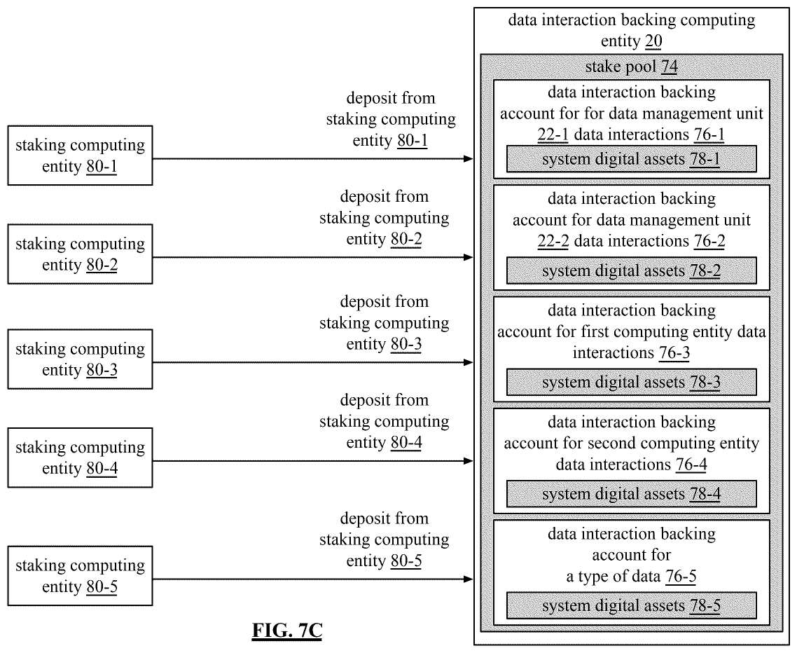

FIGS. 7A-7C are schematic block diagrams of examples of staking entities of a system digital asset-backed data interaction system. In FIG. 7A, the staking entities include the first computing entity 12 and/or the second computing entity 14. The first computing entity 12 is associated with a data interaction backing account 76-1 and deposits system digital assets 78-1 to back data interactions of the first computing entity 12. The second computing entity 14 is associated with a data interaction backing account 76-n and deposits system digital assets 78-n to back data interactions of the second computing entity 14. For example, to back a data interaction between the first and second computing entities 12 and 14, the second computing entity 14 deposits system digital assets 78-n into the data interaction backing account 76-n.

An amount of the system digital assets 78-n are locked for the data interaction and when the data interaction is successful, the amount of system digital assets are released such that the second computing entity 14 may withdraw, transfer, and/or exchange the amount of system digital assets. When the data interaction is unsuccessful, the amount of system digital assets are transferred to the first computing entity and/or the data interaction computing entity as determined by the data interaction terms.

In another example, to back a data interaction between the first and second computing entities 12 and 14, the second computing entity 14 deposits system digital assets 78-1 into the data interaction backing account 76-1 (i.e., the account associated with the first computing entity 12).

An amount of the system digital assets 78-1 are locked for the data interaction and when the data interaction is successful, the amount of system digital assets are released and transferrable to the second computing entity 14. When the data interaction is unsuccessful, the amount of system digital assets is released to the data interaction backing account 76-1 such that the first computing entity may withdraw, transfer, and/or exchange the amount of system digital assets. When the parties to a data interaction provide their own system digital asset collateral backing, providing interaction fees to the data interaction computing entity may not be required.

In FIG. 7B, the staking entities include data management computing entities 50-1 through 50-n. To become staking entities of the system digital asset-backed data interaction system, the data management computing entities 50-1 through 50-n deposit system digital assets 78-1 through 78-n in respective, associated data interaction backing accounts 76-1 through 76-n of the data interaction backing computing entity 20 to back data interactions of the system digital asset-backed data interaction system.

For example, the data management computing entity 50-1 is associated with a data interaction backing account 76-1 and deposits system digital assets 78-1 to back data interactions of data management units 22-1-1 through 22-1-n of first computing entities 12-1 through 12-n. The data management computing entity 50-2 is associated with a digital asset backing account 76-2 and deposits system digital assets 78-2 to back data interactions of data management units 22-2-1 through 22-2-n of second computing entities 14-1 through 14-n.

In another example, the data management computing entity 50-n is associated with a digital asset backing account 52-n and deposits system digital assets 78-n to back data interactions of a data management unit 22-n. The data management computing entity 50-n also deposits system digital assets 78-n to back data interactions of data management units 22-2-1 through 22-2-n of second computing entities 14-1 through 14-n.

Even though the data management computing entities 50-1 through 50-n are not parties to the data interactions, they are incentivized to back the data management unit interactions of their users by receiving rewards from the data interaction backing entity such as a percentage of system digital assets back on successful data interactions (e.g., where one or more participants of the data interaction provides an interaction fee for the collateral backing service and the interaction fee is converted to rewards).

The data management computing entities 50-1 through 50-n may require that its users provide and maintain information to prove a level of trustworthiness prior and during use of the data management units (e.g., a credit score, bank account information, a history of successful data interactions,). Further, the data management computing entities 50-1 through 50-n may only back certain types of data interactions (e.g., lower risk data interactions, data interactions between two known entities, data interactions not to include loans, etc.).

In FIG. 7C, the staking entities include a plurality of staking computing entities 80-1 through 80-5. The staking computing entities 80-1 through 80-5 may be any computing entity such as a user computing device, a data management computing entity, etc. The staking entity 80-1 deposits system digital assets 78-1 in data interaction backing account 76-1 to back data interactions of a data management unit 22-1. The staking entity 80-2 deposits system digital assets 78-2 in data interaction backing account 76-2 to back data interactions of a data management unit 22-2.

The staking entity 80-3 deposits system digital assets 78-3 in data interaction backing account 76-3 to back data interactions of a first computing entity. For example, the first computing entity is associated with a trusted organization such that staking entities have a level of trust in first computing entity data interactions. The staking entity 80-4 deposits system digital assets 78-4 in data interaction backing account 76-4 to back data interactions of a second computing entity. For example, the second computing entity is associated with a trusted organization such that staking entities have a level of trust in second computing entity data interactions. The staking entity 80-5 deposits system digital assets 78-5 in data interaction backing account 76-5 to back data interactions associated with a particular type of data. For example, the type of data may include a trusted cryptocurrency, a contract, a loan, confidential documents, audio files, etc.

For every successful transaction involving a particular data interaction backing account, the staking entities associated with the data interaction backing account receive a percentage of rewards. For example, the rewards may be based on transaction fees from merchants and/or other parties of a data interaction.

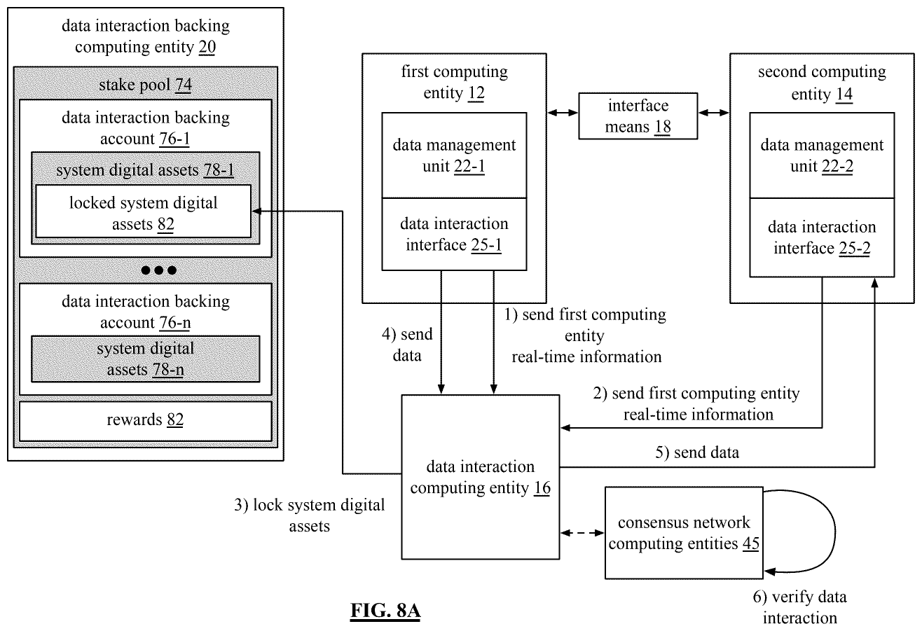

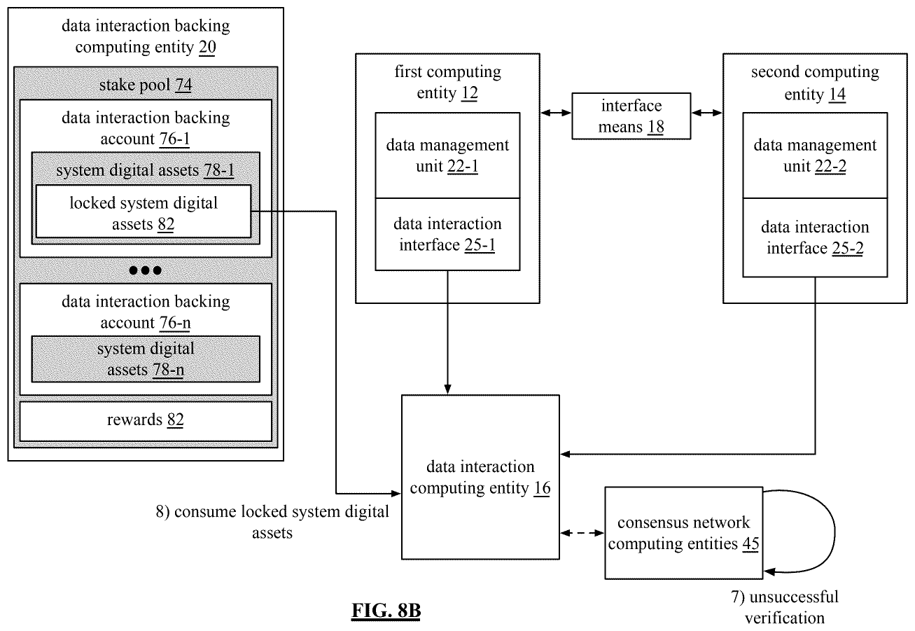

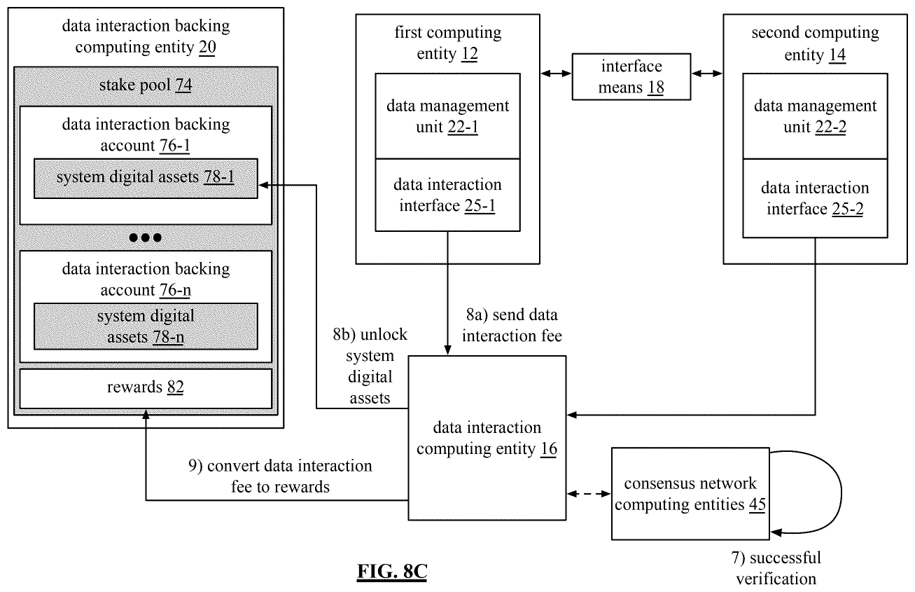

FIGS. 8A-8C are flowcharts of an example of a method of facilitating a data interaction of a system digital asset-backed data interaction system. FIGS. 8A-8C depict a simplified version of the system digital asset-backed data interaction system of previous Figures and includes a first computing entity 12, a second computing entity 14, an interface means 18, a data interaction computing entity 16, a data interaction backing computing entity 20, and a plurality of consensus network computing entities 45. The plurality of consensus network computing entities 45 is a plurality of computing entities that perform computations to verify transactions on a type of distributed ledger technology (e.g., a blockchain). Each of the first and second computing entities 12 and 14 include a data management unit 22-1 and 22-2 respectively. The data management units 22-1 and/or 22-2 may be digital wallet applications or network enabled smart contract applications (e.g., data interaction smart contract wallets) installed on or otherwise usable by the first and second computing entities 12 and 14 that function to store and manage (e.g., transfer, trade, custody, etc.) data.

The data management units 22-1 and 22-2 include data interaction interfaces 25-1 and 25-2 operable to interface with the data interaction computing entity 16. The data interaction interfaces 25-1 and 25-2 are data interaction computing entity application programming interfaces (APIs) integrated into data management units 22-1 and 22-2 that allow the first and second computing entities 12 and 14 to connect to the data interaction computing entity 16 for data interactions.

The data interaction backing computing entity 20 may be a part of or separate from the data interaction computing entity 16. The data interaction backing computing entity 20 stores (or otherwise has access to) system digital assets (e.g., system cryptocurrency, system tokens, etc.) in a stake pool 74 as collateral to back data interactions of the system digital asset-backed data interaction system. The stake pool 74 includes data interaction backing accounts 76-1 through 76-n that are associated with one or more data management units, the first computing entity, the second computing entity, a data type, another computing entity, etc. A data type includes a type of digital asset (e.g., a cryptocurrency used in a payment), loans, contracts, confidential information, etc.

A staking entity is a computing entity that deposits system digital assets into a data interaction backing account to back one or more data interactions of the system digital asset-backed data interaction system. A staking entity may be a data management computing entity associated with one or more data management units, a user computing device, a party to the data interaction, etc.

In FIG. 8A, the method begins with step 1 where the data interaction computing entity obtains first computing entity real-time information from the first computing entity 12. For example, the first computing entity 12 initiates a data interaction with the second computing entity 14 via the interface means 18 and sends the first computing entity real-time information to the data interaction computing entity 16 via the data interaction interface 25-1 of the data management unit 22-1. The first computing entity real-time information includes at least an identifier (e.g., a user ID), a type of data interaction, and the data involved. The first computing entity real-time information may also include data interaction terms such as a time frame for the data interaction, a performance requirement (e.g., a signature, a payment, etc.), an acknowledgement (e.g., a receipt of payment), an action (e.g., a response), etc.

The method continues with step 2 where the data interaction computing entity obtains second computing entity real-time information from the second computing entity 14. For example, when the first computing entity 12 initiates the data interaction with the second computing entity 14, the second computing entity 14 sends the second computing entity real-time information to the data interaction computing entity 16 via the data interaction interface 25-2 of the data management unit 22-2.

In another example, the second computing entity 14 sends the second computing entity real-time information to the first computing entity 12 and the first computing entity 12 sends the first and second computing entity real-time information to the data interaction computing entity 16. In another example, the first computing entity 12 sends the first computing entity real-time information to the second computing entity 14 and the second computing entity 14 sends the first and second computing entity real-time information to the data interaction computing entity 16.

The second computing entity real-time information includes at least an identifier (e.g., a user ID, a merchant ID, etc.). The second computing entity real-time information may also include one or more additional data interaction terms such as a time requirement for the data interaction, a performance requirement, etc. The first computing entity real-time information and the second computing entity real-time information may include further an amount of data involved in the data interaction, an amount of system digital assets, an amount of digital assets to purchase and/or borrow system digital assets, etc.

The first computing entity real-time information and the second computing entity real-time information may include further information and/or metadata such as loyalty information, personal information (address, name, etc.), shipping details, bill splitting information, a request for additional information, etc.

The method continues with step 3 where the data interaction computing entity 16 locks an amount of system digital assets to back the data interaction. For example, when the data interaction computing entity 16 receives the first and second computing entity real-time information, the data interaction computing entity 16 initiates: 1) a real-time data interaction process and 2) a nonreal-time data interaction process to reconcile the data interaction with the data interaction backing computing entity 20. The reconciliation of the data interaction with the data interaction backing computing entity 20 occurs within a time frame that is longer than the time frame of the real-time data interaction. For example, the reconciliation of the data interaction with the data interaction backing computing entity 20 occurs over the course of minutes whereas the time frame of the real-time data interaction takes a few seconds.

Within the real-time data interaction process, when at least the first computing entity real-time information is received, the data interaction computing entity 16 instructs the data interaction backing computing entity 20 to lock an amount of system digital assets associated with the data interaction. The amount of system digital assets locked is received by one or more of the first and second computing entities or from the stake pool 74 of stored system digital assets associated with the one or more of the first and second computing entities and/or the data involved in the data interaction.

In this example, one or more of the first and second computing entities and/or the data involved is associated with the data interaction backing account 76-1. For example, the data interaction backing account 76-1 is associated with the data management unit 22-1 of the first computing entity 12. The data interaction backing computing entity 20 locks an amount of system digital assets 78-1 to back the data interaction (e.g., “locked system digital assets 82”). The amount of locked of system digital assets 82 may be based on one or more of the type of data interaction, the first computing entity 12 (e.g., a trustworthiness level, a data management unit 22-1 balance, a first computing entity request, etc.), the second computing entity 14 (e.g., a trustworthiness level, a data management unit 22-2 balance, a second computing entity request, etc.), an amount involved in the data interaction, and a default amount.

The method continues with step 4 where during the real-time data interaction process, the data interaction computing entity 16 receives the data from the first computing entity 12 to use in the data interaction. For example, the first computing entity 12 sends the data to the data interaction computing entity 16 via its data interaction interface 25-1 as part of the first computing entity real-time information. The data interaction computing entity 16 may convert the data into a format desired by the second computing entity. The desired format may be a different type of digital asset (e.g., a cryptocurrency) and/or a different data format type (e.g., a document, pdf, audio file, an encrypted format, a compressed format, etc.).

For example, when the data interaction is a digital asset-based payment, the data interaction computing entity 16 connects to one or more digital asset exchange entities to exchange the amount of the digital asset received from the first computing entity 12 to an amount in a desired asset format requested by the second computing entity 14. As another example, when the data interaction is sending confidential information, the data interaction computing entity 16 encrypts the information to produce encrypted information and sends the encrypted information to the second computing entity 14

The method continues with step 5 where the data interaction computing entity 16 sends the data to the second computing entity 14 to complete the real-time portion of the data interaction. When the data itself is not managed by a distributed ledger technology (e.g., a contract), the data interaction computing entity 16 interacts with a data interaction smart contract managed by a blockchain verified by consensus network computing entities to embed and verify the data and/or data interaction terms. Interacting with the data interaction smart contract to embed and verify the data and/or data interaction terms was discussed in greater detail with reference to FIGS. 3-5. Upon or prior to embedding the data and/or the data interaction terms, the data interaction computing entity 16 sends at least a portion of the data to the second computing entity 14 to complete the real-time portion of the data interaction.

For example, when the data interaction is a contract, the data interaction computing entity 16 sends at least a portion of data (e.g., the contract, a signature page, etc.) to the second computing entity 14 to complete the real-time portion of the data interaction (e.g., receive a signature, etc.). In another example, when the data interaction is a loan, the data interaction computing entity 16 sends at least a portion of data (e.g., the loan agreement, a signature page, etc.) to the second computing entity 14 to complete the real-time portion of the data interaction (e.g., receive a signature, etc.).

Continuing with the nonreal-time process, the method continues with step 6 where the data interaction computing entity 16 connects to the plurality of consensus network computing entities 45 to verify the data interaction. For example, when the data interaction is a digital asset-based payment, the data interaction computing entity 16 connects to the plurality of consensus network computing entities 45 associated with a digital asset blockchain of the digital asset used for payment to verify the amount of the digital asset received from the first computing entity 12. The consensus network implements a verification process that may take minutes to hours of time.

In another example, when the data interaction is a contract, the data interaction computing entity 16 verifies whether the data interaction terms are met. For example, the data interaction computing entity 16 interacts with a data interaction smart contract managed by a blockchain verified by a plurality of consensus network computing entities 45. Data inputs to and from the data interaction smart contract (e.g., a contract signature, a contract performance, etc.) trigger events in the smart contract that verify whether the data interaction terms were met. The data interaction computing entity 16 provides and receives data inputs from the data interaction smart contract to verify that the data interaction terms are executed.

The method continues on FIG. 8B with step 7 where the data interaction computing entity 16 does not verify the terms of the data interaction and the data interaction is unsuccessful. For example, if fraudulent activity occurs in a digital asset-based payment data interaction (e.g., the first computing entity acts maliciously to spend at two merchants simultaneously, software of the data management unit 22-1 is corrupted, etc.), a desired number of confirmations are not received from the plurality of consensus network computing entities 45. As another example, the data interaction computing entity 16 receives a data input from a smart contract verified by the plurality of consensus network computing entities 45 the that a data interaction term is not verified.

The method continues with step 8 where when the data interaction computing entity 16 does not verify the data interaction, the data interaction computing entity 16 and/or the data interaction smart contract perform a consume instruction to consume the amount of locked system digital assets 82. The consume instruction involves transferring the system digital assets via an on-chain transaction from one address to another.

For example, if fraudulent activity occurs in a digital asset-based payment data interaction (e.g., the first computing entity acts maliciously to spend at two merchants simultaneously, software of the data management unit 22-1 is corrupted, etc.), the data interaction computing entity 16 consumes the amount of system digital asset associated with the digital asset interaction. As a specific example, if the first computing entity 12 attempts to double spend a transaction, the verification (e.g., the desired number of confirmations in a Bitcoin blockchain example) will not be received and the data interaction computing entity 16 will not be able to verify the amount of the digital asset received by the first computing entity 12.

If the verification is not received, the data interaction computing entity 16 withdraws (e.g., consumes) the amount of system digital asset locked by the digital asset backing entity 20 to cover the real-time digital asset interaction that occurred with the second computing entity 14. Consuming the amount of system digital asset means that the amount of system digital asset (or digital assets used to borrow system digital assets) is transferred (e.g., via an on-chain transaction) from an address associated with the data interaction staking entity (e.g., the data interaction backing account 76-1) to an address associated with the data interaction computing entity 16.

In another example, when the data interaction is not a digital asset-based payment and the system digital assets are provided by a party to the data interaction (e.g., the first computing entity deposits system digital assets to back a loan agreement) or another staking entity, and verification is not received, the smart contract transfers the system digital assets to the other party of the data interaction as per the data interaction terms. In another embodiment, the smart contract transfers the system digital assets to the data interaction computing entity 16 and the data interaction computing entity 16 exchanges the system digital assets to a digital asset desired by the other party. The data interaction computing entity 16 sends the desired digital assets to the other party of the data interaction as per the contract terms.

Alternatively, the method of FIG. 8A continues on FIG. 8C with alternative steps 7-9. At step 7, the data interaction computing entity 16 verifies the terms of the data interaction and the data interaction is successful. For example, the data interaction computing entity 16 connects to a plurality of consensus network computing entities 45 (“a consensus network”) associated with the digital asset that verify the amount of the digital asset received from the first computing entity 12. In another example, when the data interaction is a contract, the data interaction computing entity 16 verifies whether the data interaction terms are met. To verify whether the data interaction terms are met, the data interaction computing entity 16 receives one or more data inputs from a data interaction smart contract managing the data interaction.

The method continues with steps 8a and 8b. Steps 8a and 8b may occur concurrently, step 8a may occur slightly before step 8b, or step 8b may occur slightly before step 8a. In step 8a, when the data interaction computing entity 16 verifies the data interaction, the data interaction computing entity 16 obtains a data interaction fee from the first computing entity 12. For example, the first computing entity 12 sends the data interaction fee upon receipt of a successful data interaction. In another example, the second computing entity 14 sends the data interaction fee. In another example, the first and second computing entity 12 and 14 share the costs of the data interaction fee (e.g., by an agreed upon percentage).

In step 8b, when the data interaction computing entity 16 verifies the data interaction, the data interaction computing entity 16 instructs the digital asset backing entity 20 to release (e.g., unlock) the amount of the locked system digital assets associated with the data interaction. The method continues with step 9 where the data interaction computing entity 16 converts the data interaction fee into rewards 82 for the stake pool 74. For example, the first computing entity 12 provides a fiat currency for the data interaction fee. The data interaction computing entity 16 converts the fiat currency to system digital assets and either pools the system digital assets into rewards 82 where they are distributable or the data interaction computing entity 16 distributes the system digital assets to the one or more data interaction backing accounts associated with the successful data interaction. In this example, the rewards are distributable to the data interaction backing account 76-1 for locking the system digital assets for the data interaction.

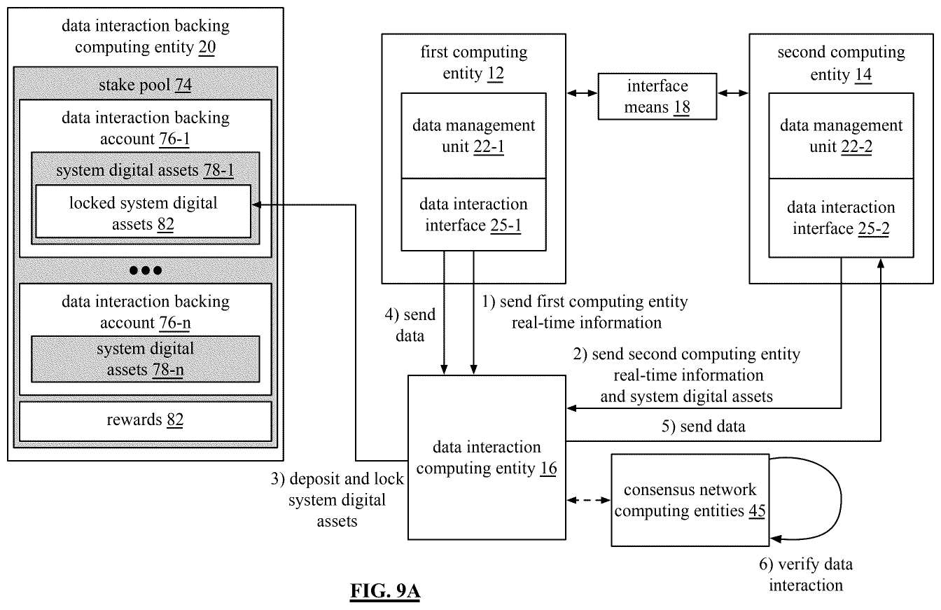

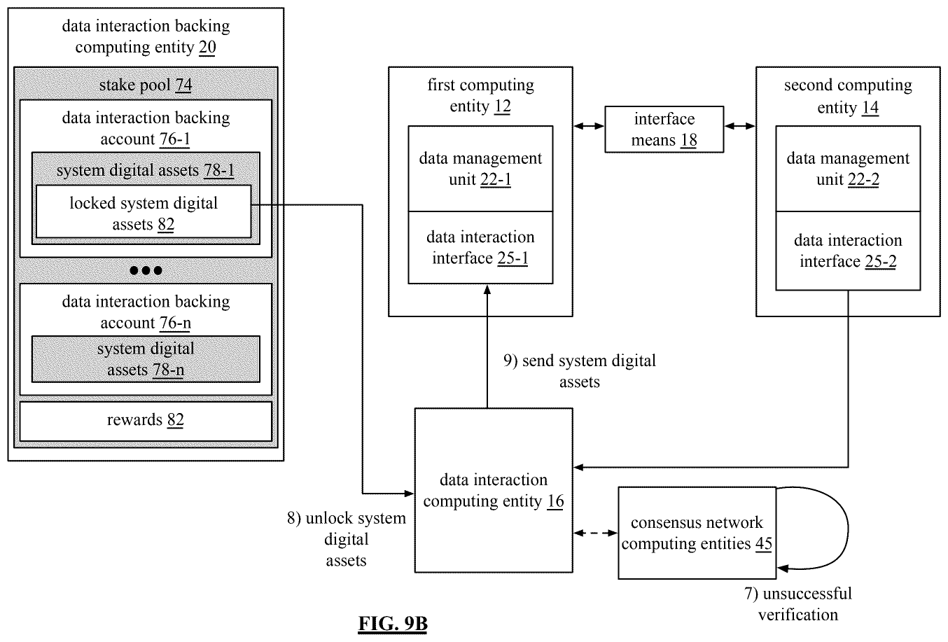

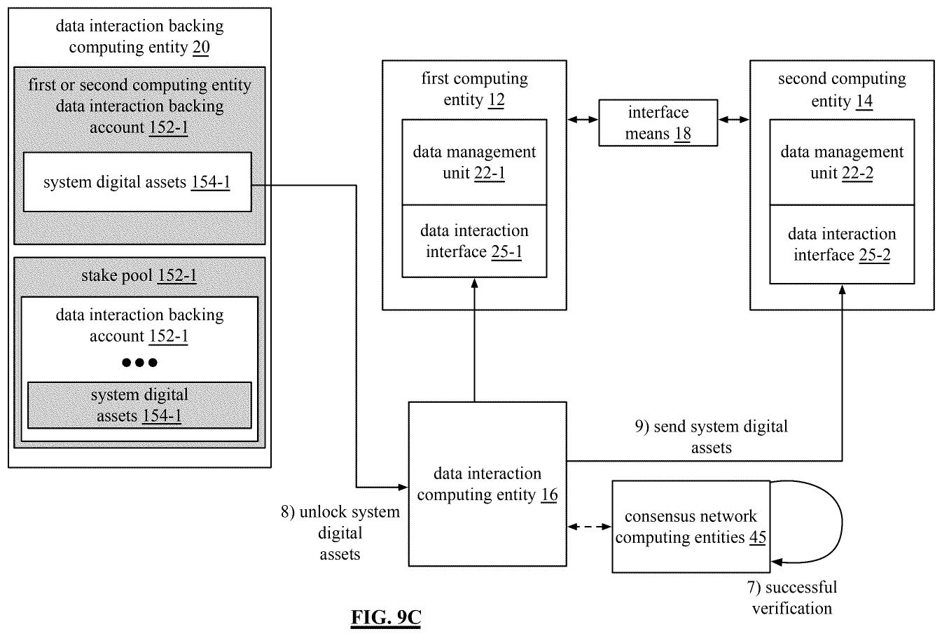

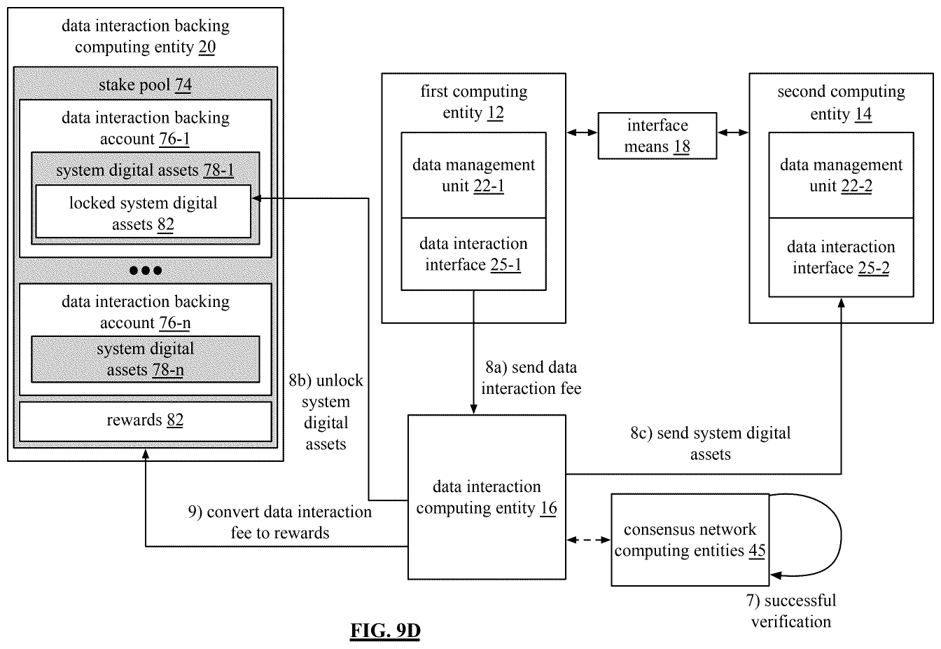

FIGS. 9A-9D are flowcharts of an example of a method of facilitating a data interaction of a system digital asset-backed data interaction system. FIGS. 9A-9CD depict a simplified version of the system digital asset backed data interaction system of previous Figures that include a first computing entity 12, a second computing entity 14, an interface means 18, a data interaction computing entity 16, a data interaction backing computing entity 20, and a plurality of consensus network computing entities 45. The first computing entity 12, the second computing entity 14, the interface means 18, the data interaction computing entity 16, the data interaction backing computing entity 20, and the plurality of consensus network computing entities 45 operate similarly to the first computing entity 12, the second computing entity 14, the interface means 18, the data interaction computing entity 16, the data interaction backing computing entity 20, and the plurality of consensus network computing entities 45 of previous Figures.

The data interaction backing computing entity 20 stores (or otherwise has access to) system digital assets (e.g., system cryptocurrency, system tokens, etc.) in a stake pool 74 as collateral to back data interactions of the system digital asset-backed data interaction system. The stake pool 74 includes data interaction backing accounts 76-1 through 76-n that are associated with one or more data management units, the first computing entity, the second computing entity, a data type, another computing entity, etc. A data type includes a type of digital asset (e.g., a cryptocurrency used in a payment), loans, contracts, confidential information, etc.

A staking entity is a computing entity that deposits system digital assets into a data interaction backing account to back one or more data interactions of the system digital asset-backed data interaction system. A staking entity may be a data management computing entity associated with one or more data management units, a user computing device (such as the first and/or second computing entities), etc.

In FIG. 9A, the method begins with step 1 where the data interaction computing entity obtains first computing entity real-time information from the first computing entity 12. For example, the first computing entity 12 initiates a data interaction with the second computing entity 14 via the interface means 18 and sends the first computing entity real-time information to the data interaction computing entity 16 via the data interaction interface 25-1 of the data management unit 22-1. The first computing entity real-time information includes at least an identifier (e.g., a user ID), a type of data interaction, and the data involved. The first computing entity real-time information may also include data interaction terms such as a time frame for the data interaction, a performance requirement (e.g., a signature, a payment, etc.), an acknowledgement (e.g., a receipt of payment), an action (e.g., a response), etc.

The method continues with step 2 where the data interaction computing entity 16 obtains second computing entity real-time information from the second computing entity 14. For example, when the first computing entity 12 initiates the data interaction with the second computing entity 14, the second computing entity 14 sends the second computing entity real-time information to the data interaction computing entity 16 via the data interaction interface 25-2 of the data management unit 22-2.

In another example, the second computing entity 14 sends the second computing entity real-time information to the first computing entity 12 and the first computing entity 12 sends the first and second computing entity real-time information to the data interaction computing entity 16. In another example, the first computing entity 12 sends the first computing entity real-time information to the second computing entity 14 and the second computing entity 14 sends the first and second computing entity real-time information to the data interaction computing entity 16.

The second computing entity real-time information includes at least an identifier (e.g., a user ID, a merchant ID, etc.). The second computing entity real-time information may also include one or more additional data interaction terms such as a time requirement for the data interaction, a performance requirement, etc. The first computing entity real-time information and the second computing entity real-time information may include further an amount of data involved in the data interaction, an amount of system digital assets, an amount of digital assets to purchase and/or borrow system digital assets, etc.

The first computing entity real-time information and the second computing entity real-time information may include further information and/or metadata such as loyalty information, personal information (address, name, etc.), shipping details, bill splitting information, a request for additional information, etc.

In this example, the data interaction initiation notified the second computing entity 14 that a collateral backing was required. The second computing entity 14 sends an amount of system digital assets to back the data interaction along with the second computing entity real-time information. In another example, the second computing entity sends an amount of a desired asset (e.g., a cryptocurrency, fiat currency, etc.) and the data interaction computing entity 16 exchanges the amount of desired asset for a substantially equivalent amount of system digital assets. In another example, the first computing entity real-time information includes a request for backing and the data interaction computing entity 16 requests an amount of system digital assets from the second computing entity 14 before, after, or during receiving the second computing entity real-time information.

The amount of system digital assets 82 requested may be based on one or more of the type of data interaction, the first computing entity 12 (e.g., a trustworthiness level, a data management unit 22-1 balance, a first computing entity request, etc.), the second computing entity 14 (e.g., a trustworthiness level, a data management unit 22-2 balance, a second computing entity request, etc.), an amount involved in the data interaction, and a default amount.

The method continues with step 3 where the data interaction computing entity 16 deposits the system digital assets in an account associated with the second computing entity 14 and locks the amount of system digital assets to back the data interaction (“locked system digital assets 82”). For example, when the data interaction computing entity 16 receives the first and second computing entity real-time information, the data interaction computing entity 16 initiates: 1) a real-time data interaction process and 2) a nonreal-time data interaction process to reconcile the data interaction with the data interaction backing computing entity 20. The reconciliation of the data interaction with the data interaction backing computing entity 20 occurs within a time frame that is longer than the time frame of the real-time data interaction. For example, the reconciliation of the data interaction with the data interaction backing computing entity 20 occurs over the course of minutes whereas the time frame of the real-time data interaction takes a few seconds.

Within the real-time data interaction process, when at least the first computing entity real-time information and the system digital assets are received, the data interaction computing entity 16 instructs the data interaction backing computing entity 20 to lock the amount of system digital assets associated with the data interaction.

The method continues with step 4 where during the real-time data interaction process, the data interaction computing entity 16 obtains the data from the first computing entity 12 to use in the data interaction. For example, the first computing entity 12 sends the data to the data interaction computing entity 16 via its data interaction interface 25-1 as part of the first computing entity real-time information. The data interaction computing entity 16 may convert the data into a format desired by the second computing entity.

For example, when the data interaction is a digital asset-based payment, the data interaction computing entity 16 connects to one or more digital asset exchange entities to exchange the amount of the digital asset received from the first computing entity 12 to an amount in a desired asset format requested by the second computing entity 14.

The method continues with step 5 where the data interaction computing entity 16 sends the data to the second computing entity 14 to complete the real-time portion of the data interaction. When the at least the first computing entity real-time information includes data interaction terms, the data interaction computing entity 16 interacts with a data interaction smart contract managed by a blockchain verified by consensus network computing entities to embed and verify the data interaction terms. Interacting with the data interaction smart contract to embed and verify the data interaction terms was discussed in greater detail with reference to FIGS. 3-5. Upon setting the data interaction terms, the data interaction computing entity 16 sends at least a portion of the data to the second computing entity 14 to complete the real-time portion of the data interaction.

For example, when the data interaction is a contract, the data interaction computing entity 16 sends at least a portion of data (e.g., the contract, a signature page, etc.) to the second computing entity 14 to complete the real-time portion of the data interaction (e.g., receive a signature, etc.). In another example, when the data interaction is a loan, the data interaction computing entity 16 sends at least a portion of data (e.g., the loan agreement, a signature page, etc.) to the second computing entity 14 to complete the real-time portion of the data interaction (e.g., receive a signature, etc.).

Continuing with the nonreal-time process, the method continues with step 6 where the data interaction computing entity 16 connects to the plurality of consensus network computing entities 45 to verify the data interaction. For example, when the data interaction is a digital asset-based payment, the data interaction computing entity 16 connects to a consensus network computing entities 45 associated with a digital asset blockchain that verify the amount of the digital asset received from the first computing entity 12. The consensus network implements a verification process that may take minutes to hours of time.

In another example, when the data interaction is a contract, the data interaction computing entity 16 verifies whether the data interaction terms are met. For example, the data interaction computing entity 16 interacts with a data interaction smart contract managed by a blockchain verified by consensus network computing entities 45. Data inputs to and from the data interaction smart contract indicate whether the contract was executed by both parties and whether system digital asset backed performance was completed. For example, the system digital asset backed performance may include the signing of the contract, a performance under the contract (e.g., a service, delivery of goods, etc.), a condition of the performance (e.g., a quality level, a time frame, etc.), etc. The data interaction computing entity 16 provides and receives data inputs from the data interaction smart contract to verify that the terms are executed.

The method continues on FIG. 9B with step 7 where the data interaction computing entity 16 does not verify the terms of the data interaction and the data interaction is unsuccessful. For example, if fraudulent activity occurs in a digital asset-based payment data interaction (e.g., the first computing entity acts maliciously to spend at two merchants simultaneously, software of the data management unit 22-1 is corrupted, etc.), a desired number of confirmations are not received from the plurality of consensus network computing entities 45. As another example, the data interaction computing entity 16 receives a data input from a data interaction smart contract executed by the plurality of consensus network computing entities 45 that the data interaction is not verified.

The method continues with step 8 where when the data interaction computing entity 16 does not verify the terms of the data interaction, the data interaction computing entity 16 unlocks the amount of locked system digital assets 82. The method continues with step 9 where the data interaction computing entity 16 sends the system digital assets 82 to the first computing entity 12. Because the unsuccessful data interaction is due to a problem with the second computing entity 14 (e.g., a fraudulent payment attempt, a failed contract performance, a late loan payment, etc.), the system digital assets are sent to the first computing entity 12 as compensation for the inconvenience and/or lost funds.

Alternatively, the method of FIG. 9A continues on FIG. 9C with alternative steps 7-9. At step 7, the data interaction computing entity 16 verifies the terms of the data interaction and the data interaction is successful. For example, the data interaction computing entity 16 connects to a plurality of consensus network computing entities 45 (“a consensus network”) associated with the digital asset that verify the amount of the digital asset received from the first computing entity 12. In another example, when the data interaction is a contract, the data interaction computing entity 16 verifies whether the data interaction terms are met. To verify whether the data interaction terms are met, the data interaction computing entity 16 receives one or more data inputs from a data interaction smart contract managing the data interaction.

The method continues with step 8 where when the data interaction computing entity 16 verifies the terms of the data interaction, the data interaction computing entity 16 unlocks the amount of locked system digital assets 82. The method continues with step 9 where the data interaction computing entity 16 sends the system digital assets 82 to the second computing entity 14. Because the second computing entity 14 provided the system digital assets to ensure the data interaction, when the data interaction is successful, the system digital assets are sent back to the second computing entity 14. In another example, the data interaction computing entity 16 converts the system digital assets to an asset format desired by the second computing entity 14 (e.g., a cryptocurrency, fiat currency, etc.) and sends the assets in the desired asset format to the second computing entity 14.

Alternatively, the method of FIG. 9A continues on FIG. 9D with alternative steps 7-9. At step 7, the data interaction computing entity 16 verifies the terms of the data interaction and the data interaction is successful. For example, the data interaction computing entity 16 connects to a plurality of consensus network computing entities 45 (“a consensus network”) associated with the digital asset that verify the amount of the digital asset received from the first computing entity 12. In another example, when the data interaction is a contract, the data interaction computing entity 16 verifies whether the data interaction terms are met. To verify whether the data interaction terms are met, the data interaction computing entity 16 receives one or more data inputs from a data interaction smart contract managing the data interaction.

The method continues with steps 8a-8c. Steps 8a-8c may occur concurrently, step 8a may occur slightly before step 8b, step 8b may occur slightly before step 8a, etc. In step 8a, when the data interaction computing entity 16 verifies the data interaction, the data interaction computing entity 16 obtains a data interaction fee from the first computing entity 12. For example, the first computing entity 12 sends the data interaction fee upon receipt of a successful data interaction. In another example, the second computing entity 14 sends the data interaction fee. In another example, the first and second computing entity 12 and 14 share the costs of the data interaction fee (e.g., by an agreed upon percentage).

In step 8b, when the data interaction computing entity 16 verifies the data interaction, the data interaction computing entity 16 instructs the digital asset backing entity 20 to release (e.g., unlock) the amount of the locked system digital assets associated with the real-time digital asset interaction. In step 8c, the data interaction computing entity 16 sends the system digital assets 82 to the second computing entity 14. Because the second computing entity 14 provided the system digital assets to ensure the data interaction, when the data interaction is successful, the system digital assets are sent back to the second computing entity 14. In another example, the data interaction computing entity 16 converts the system digital assets to an asset format desired by the second computing entity 14 (e.g., a cryptocurrency, fiat currency, etc.) and sends the assets in the desired asset format to the second computing entity 14.

The method continues with step 9 where the data interaction computing entity 16 converts the data interaction fee into rewards 82 for the stake pool 74. For example, the first computing entity 12 provides a fiat currency for the data interaction fee. The data interaction computing entity 16 converts the fiat currency to system digital assets and either pools the system digital assets into rewards 82 where they are distributable or the data interaction computing entity 16 distributes the system digital assets to the one or more data interaction backing accounts associated with the successful data interaction. In this example, the rewards are distributable to the data interaction backing account 76-1 associated with the second computing entity and/or other data interaction backing accounts. For example, data interaction fees such as these may be distributed among staking entities as an overall incentive to stake other data interactions.

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data. While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A computer readable memory comprises:
a first memory element that stores operational instructions that, when executed by a data interaction computing entity of a system digital asset-based data interaction system, causes the data interaction computing entity to:
obtain first and second computing entity real-time information regarding a data interaction between a first computing entity of the system digital asset-based data interaction system and a second computing entity of the system digital asset-based data interaction system, wherein the data interaction includes the first computing entity providing data to the second computing entity, and wherein processing the data interaction includes executing a real-time data interaction process and a nonreal-time data interaction process;
instruct a data interaction backing computing entity of the system digital asset-based data interaction system to lock an amount of system digital assets to back the data interaction, wherein one or more staking computing entities store system digital assets in a stake pool of the system digital asset-backed data interaction system to back one or more data interactions of the system digital asset-based data interaction system; and
when the data interaction is successful:
obtain a data interaction fee from one or more of the first and second computing entities;
convert the data interaction fee to system digital assets; and
provide the system digital assets to the stake pool.

2. The computer readable memory of claim 1 further comprises:
a second memory element that stores operational instructions that, when executed by the data interaction computing entity, causes the data interaction computing entity to execute the real-time data interaction process by:
obtaining the data from the first computing entity; and
providing the data to the second computing entity.

3. The computer readable memory of claim 1, wherein the second memory element further stores operational instructions that, when executed by the data interaction computing entity, causes the data interaction computing entity to further execute the real-time data interaction process by:
determining data interaction terms based on the first and second computing entity real-time information and a type of the data interaction.

4. The computer readable memory of claim 1 further comprises:
a second memory element that stores operational instructions that, when executed by the data interaction computing entity, causes the data interaction computing entity to execute the real-time data interaction process by:
obtaining the data from the first computing entity;
converting the data to second data, wherein the data includes a first data format and the second data includes a second data format, and wherein the second data format is preferred by the second computing entity; and
providing the second data to the second computing entity.

5. The computer readable memory of claim 4, wherein the second memory element further stores operational instructions that, when executed by the data interaction computing entity, causes the data interaction computing entity to convert the data to the second data by:
when the data is a digital asset:
connecting to one or more digital asset exchange entities to exchange the digital asset to a substantially equivalent amount of a desired asset, wherein the desired asset is the second data.

6. The computer readable memory of claim 1 further comprises:
a second memory element that stores operational instructions that, when executed by the data interaction computing entity, causes the data interaction computing entity to execute the nonreal-time data interaction process by:
connecting to a plurality consensus network computing entities associated with a distributed ledger technology, wherein the plurality of consensus network computing entities performs a verification process to verify the data interaction;
when the verification process is successful:
determining that the data interaction is successful; and
instructing the data interaction backing computing entity to unlock the amount of system digital assets; and
when the verification process is unsuccessful:
determining that the data interaction is unsuccessful; and
instructing the data interaction backing computing entity to facilitate a consume instruction of the amount of system digital assets.

7. The computer readable memory of claim 1 further comprises:
a second memory element that stores operational instructions that, when executed by the data interaction computing entity, causes the data interaction computing entity to:
convert the data interaction fee to system digital assets rewards; and
distribute the system digital assets rewards to at least one of the one or more staking computing entities.

8. The computer readable memory of claim 1, wherein the data interaction backing computing entity is a part of the data interaction computing entity.
